(19) United States
(12) Patent Application Publication
(10) Pub. No.: US 2018/0220288 A1
(43) Pub. Date: Aug. 2, 2018

(54) METHOD AND APPARATUS FOR TRANSMITTING AND RECEIVING SYSTEM INFORMATION

(71) Applicant: Samsung Electronics Co., Ltd., Suwon-si (KR)

(72) Inventors: Anil AGIWAL, Suwon-si (KR); Mangesh Abhimanyu INGALE, Yongin-si (KR)

(21) Appl. No.: 15/887,361

(22) Filed: Feb. 2, 2018

(30) Foreign Application Priority Data
Feb. 2, 2017 (IN) 201741003817
Mar. 23, 2017 (IN) 201711010201
Apr. 25, 2017 (IN) 201711014631

(51) Int. Cl. H04W 8/00; H04W 8/24; H04W 4/30

(52) U.S. Cl. CPC H04W 8/005; H04W 76/27; H04W 4/30; H04W 8/24

(57) ABSTRACT

A communication method and system for converging a fifth generation (5G) communication system for supporting higher data rates beyond a fourth generation (4G) system with a technology for Internet of things (IoT) are provided. The communication method and system may be applied to intelligent services based on the 5G communication technology and the IoT-related technology, such as smart home, smart building, smart city, smart car, connected car, health care, digital education, smart retail, security and safety services. A method of a user equipment (UE) for receiving system information is provided. The method comprises receiving first system information from a base station, identifying whether the first system information includes information on at least one of a physical random access channel (PRACH) preamble or PRACH resources associated with second system information, transmitting a request for the second system information to the base station based on a result of the identification, and receiving the second system information from the base station.

### CROSS-REFERENCE TO RELATED APPLICATION(S)

This application is based on and claims priority under 35 U.S.C. § 119(e) of an Indian patent application number 201741003817, filed on Feb. 2, 2017, in the Indian Patent Office, of an Indian patent application number 201711010201, filed on Mar. 23, 2017, in the Indian Patent Office, and of an Indian patent application number 201711014631, filed on Apr. 25, 2017, in the Indian Patent Office, the entire disclosure of each of which is incorporated by reference herein in its entirety.

### TECHNICAL FIELD

The disclosure relates to a method and an apparatus for transmitting and receiving system information (SI).

### BACKGROUND

To meet the demand for wireless data traffic having increased since deployment of fourth generation (4G) communication systems, efforts have been made to develop an improved fifth generation (5G) or pre-5G communication system. Therefore, the 5G or pre-5G communication system is also called a ‘beyond 4G network’ or a ‘post long term evolution (LTE) System’. The 5G wireless communication system is considered to be implemented not only in lower frequency bands but also in higher frequency (mmWave) bands, e.g. 10 GHz to 100 GHz bands, so as to accomplish higher data rates. To mitigate propagation loss of the radio waves and increase the transmission distance, the beamforming, massive multiple-input multiple-output (MIMO), full dimensional MIMO (FD-MIMO), array antenna, an analog beam forming, and large scale antenna techniques are being considered in the design of the 5G wireless communication system. In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like. In the 5G system, hybrid frequency shift keying (FSK) and quadrature amplitude modulation (QAM) (FQAM) and sliding window superposition coding (SWSC) as an advanced coding modulation (ACM), filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as “sensing technology”, “wired/wireless communication and network infrastructure”, “service interface technology”, and “Security technology” have been demanded for IoT implementation, a sensor network, a machine-to-machine (M2M) communication, machine type communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies, such as a sensor network, MTC, and M2M communication may be implemented by beamforming, MIMO, and array antennas. Application of a cloud RAN as the above-described big data processing technology may also be considered to be as an example of convergence between the 5G technology and the IoT technology.

In the recent years several broadband wireless technologies have been developed to meet the growing number of broadband subscribers and to provide more and better applications and services. The second generation (2G) wireless communication system has been developed to provide voice services while ensuring the mobility of users. The third generation (3G) wireless communication system supports not only the voice service but also data service. The 4G wireless communication system has been developed to provide high-speed data service. However, the 4G wireless communication system currently suffers from lack of resources to meet the growing demand for high speed data services. Therefore, the 5G wireless communication system is being developed to meet the growing demand of various services with diverse requirements, e.g. high speed data services, support ultra-reliability and low latency applications.

In addition, the 5G wireless communication system is expected to address different use cases having quite different requirements in terms of data rate, latency, reliability, mobility etc. However, it is expected that the design of the air-interface of the 5G wireless communication system would be flexible enough to serve the user equipments (UEs) having quite different capabilities depending on the use case and market segment the UE cater service to the end customer. Example use cases the 5G wireless communication system wireless system is expected to address is enhanced mobile broadband (eMBB), massive MTC (m-MTC), ultra-reliable low latency communication (URLL) etc. The eMBB requirements like tens of Gbps data rate, low latency, high mobility so on and so forth address the market segment representing the conventional wireless broadband subscribers needing Internet connectivity everywhere, all the time and on the go. The m-MTC requirements like very high connection density, infrequent data transmission, very long battery life, low mobility address so on and so forth address the market segment representing the IoT/IoE envisioning connectivity of billions of devices. The URLL requirements like very low latency, very high reliability and variable mobility so on and so forth address the market segment representing the industrial automation application, vehicle-to-vehicle/vehicle-to-infrastructure communication foreseen as one of the enabler for autonomous cars.

In the 4G wireless communication system, enhanced node B (eNB) or base station in cell broadcast system information (SI). SI is structured into master information block (MIB) and a set of system information blocks (SIBs). MIB consists of system frame number (SFN), downlink system bandwidth and physical hybrid automatic repeat request (ARQ) feedback indicator channel (PHICH) configuration. MIB is transmitted every 40 ms. It is repeated every 10 ms wherein the first transmission occurs in subframe #0 when SFN mod 4 equals zero. MIB is transmitted on physical broadcast channel (PBCH). SIB type 1 (i.e. SIB 1) carries cell identity, tracking area code, cell barring information, value tag (common for all scheduling units), and scheduling information of other SIBs. SIB 1 is transmitted every 80 ms in subframe #5 when SFN mod 8 equals zero. SIB 1 is repeated in subframe#5 when SFN mod 2 equals zero. SIB 1 is transmitted on physical downlink shared channel (PDSCH). Other SIBs (i.e. SIB 2 to SIB 19) are transmitted in SI message wherein scheduling information on these SIBs are indicated in SIB 1.

The 5G wireless communication system is considering enhancement to deliver SI. In the 5G wireless communication SI is divided into minimum SI and other SI. Similar to LTE SI the other SI can be structured into a set of system information blocks (SIBs).

Minimum SI is periodically broadcast. Other SI can be periodically broadcasted or provided on-demand based on UE request. The minimum SI comprises basic information required for initial access to a cell and information for acquiring any other SI broadcast periodically or provisioned via on-demand basis. The minimum SI includes at least SFN, list of public land mobile network (PLMN), cell identifier (ID), cell camping parameters and random access channel (RACH) parameters. If network allows on demand mechanism, parameters required for requesting other SIB(s) (if any needed, e.g. RACH preambles for request) are also included in minimum SI.

The scheduling information in minimum SI includes an indicator which indicates whether the concerned SIB is periodically broadcasted or provided on demand. The scheduling information on the other SI includes SIB type, validity information, SI periodicity and SI-window information. The scheduling information on the other SI is provided irrespective of whether the other SI is periodically broadcasted or not. If minimum SI indicates that a SIB is not broadcasted (i.e. it is provided on demand), then UE does not assume that this SIB is a periodically broadcasted in its SI-window at every SI period. Therefore, the UE may send an SI request to receive this SIB. For other SI provided on-demand, UE can request one or more SIB(s) or all SIBs in a single request.

After sending the SI request, the mechanism to receive the requested SIB(s) is not defined yet. It can be provided in broadcast or dedicated manner based on network decision. UE needs to know where and when the requested SIB(s) are provided by network. An apparatus, a system and a method for transmitting and receiving SI response is needed.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a communication method and system for converging a fifth generation (5G) communication system for supporting higher data rates beyond a fourth generation (4G) system.

In accordance with a first aspect of the present disclosure, a method of a user equipment (UE) for receiving system information is provided. The method comprises receiving first system information from a base station, identifying whether the first system information includes information on at least one of a physical random access channel (PRACH) preamble or PRACH resources associated with second system information, transmitting a request for the second system information to the base station based on a result of the identification, and receiving the second system information from the base station.

In accordance with a second aspect of the present disclosure, a method of a base station for transmitting system information is provided. The method comprises transmitting first system information to a user equipment (UE), receiving a request for second system information from the UE based on whether the first system information includes information on at least one of a PRACH preamble or PRACH resources associated with the second system information, and transmitting the second system information to the UE.

In accordance with a third aspect of the present disclosure, a UE comprising a transceiver and a controller coupled with the transceiver is provided. The transceiver is configured to receive signals from a base station and to transmit signals to the base station. The controller is configured to control the transceiver to receive first system information from the base station, identify whether the first system information includes information on at least one of a PRACH preamble or PRACH resources associated with second system information, control the transceiver to transmit a request for the second system information to the base station based on a result of the identification, and control the transceiver to receive the second system information from the base station.

In accordance with a fourth aspect of the present disclosure, a base station comprising a transceiver and a controller coupled with the transceiver is provided. The transceiver is configured to receive signals from a UE and to transmit signals to the UE. The controller is configured to control the transceiver to transmit first system information to the UE, control the transceiver to receive a request for second system information from the UE based on whether the first system information includes information on at least one of a PRACH preamble or PRACH resources associated with the second system information, and control the transceiver to transmit the second system information to the UE.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a system information (SI) response reception according to Embodiment 1 of the disclosure;

FIG. 2 illustrates monitoring SI periods for receiving the requested SI according to Embodiment 1 of the disclosure;

FIG. 3 illustrates monitoring SI periods for receiving the requested SI according to another embodiment of the disclosure; FIG. 4 illustrates an SI response reception according to Embodiment 1A of the disclosure;

FIG. 5 illustrates monitoring SI periods for receiving the requested SI according to Embodiment 1A of the disclosure;

FIG. 6 illustrates an SI response reception according to Embodiment 1B of the disclosure;

FIG. 7 illustrates monitoring SI periods for receiving the requested SI according to Embodiment 1B of the disclosure;

FIG. 8 illustrates an SI response reception according to Embodiment 2 of the disclosure;

FIG. 9 illustrates that requested SI is provided in SI response window which starts at x ms from the SI request;

FIG. 10 illustrates an SI response reception according to Embodiment 3 of the disclosure;

FIG. 11 illustrates an SI response reception according to Embodiment 4 of the disclosure;

FIGS. 12A, 12B, and 12C illustrate SI response reception according to Embodiment 5 of the disclosure;

FIG. 13 illustrates an SI response reception according to Embodiment 6 of the disclosure;

FIG. 14 shows a MSG3 based SI request approach according to an embodiment of the disclosure;

FIG. 15 shows a MSG1 based SI request approach according to an embodiment of the disclosure;

FIG. 16 illustrates an SI request transmission according to an embodiment of the disclosure;

FIG. 17 illustrates an SI request transmission according to another embodiment of the disclosure;

FIG. 18 illustrates an SI request transmission according to another embodiment of the disclosure;

FIG. 19 shows mapping between a bit of SI Request ID and SIB according to an embodiment of the disclosure;

FIG. 20 shows mapping between a bit in SI Request ID and SIB according to another embodiment of the disclosure;

FIG. 21 shows a paging DRX cycle comprising N paging occasion (PO) (or PO interval or paging transmit interval);

FIG. 22 shows a paging DRX cycle comprising N paging transmission burst set;

FIG. 23 shows a paging DRX cycle comprising N synchronization signal burst set;

FIG. 24 is a block diagram of a user equipment (UE) according to an embodiment of the disclosure; and

FIG. 25 is a block diagram of a base station according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart. Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out operations of functions described in the flowchart.

A block of a flowchart may correspond to a module, a segment, or a code containing one or more executable instructions implementing one or more logical functions, or may correspond to a part thereof. In some cases, functions described by blocks may be executed in an order different from the listed order. For example, two blocks listed in sequence may be executed at the same time or executed in reverse order.

In this description, the words “unit”, “module” or the like may refer to a software component or hardware component, such as, for example, a field-programmable gate array (FPGA) or an application-specific integrated circuit (ASIC) capable of carrying out a function or an operation. However, a “unit”, or the like, is not limited to hardware or software. A unit, or the like, may be configured so as to reside in an addressable storage medium or to drive one or more processors. Units, or the like, may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose larger components and units. Components and units may be configured to drive a device or one or more processors in a secure multimedia card.

### System Information (SI) Response Reception

### Embodiment 1

The scheduling information on other SI may include at least one of system information block (SIB) type, validity information, SI periodicity or SI-window information in minimum SI (e.g. SIB 1) irrespective of whether other SI (consists of one or more SIBs) is periodically broadcasted or provided on demand. One or more SIB type can be mapped to SI-message broadcasted during the SI-window which occurs with a certain periodicity.

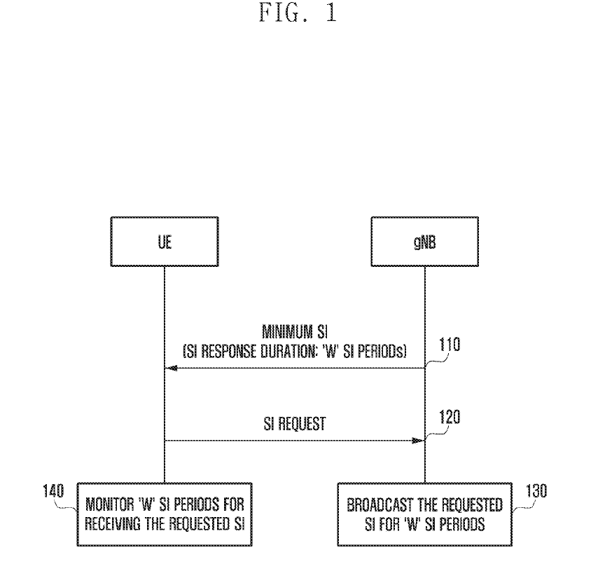

FIG. 1 illustrates an SI response reception according to Embodiment 1 of the disclosure.

As shown in FIG. 1, gNB (or eNB or base station (BS)) transmits minimum SI to user equipment (UE) at operation 110. If the minimum SI indicates that a SIB (or a SI-message) is provided on demand, then the UE does not assume that this SIB (or SI message) is broadcasted in its SI-window every SI-period and therefore the UE sends an SI request to receive this SIB (or SI-message) at operation 120. SI window of SIB is the SI window of SI-message to which this SIB is mapped.

If the SI request is received by gNB then this SIB (or SI-message) is provided (i.e. transmitted) in SI window of ‘W’ SI periods at operation 130. In other words, SIB (or SI-message) is provided in ‘W’ SI windows wherein SI window occurs every SI period. The SI period is the periodicity of SI message carrying this SIB. SI message is transmitted in SI window every SI period. The information on the SI window and SI period for an SI message may be signaled by network (i.e. gNB, eNB or BS) in minimum SI (e.g. SIB 1) at operation 110. W is number of SI periods. Alternately W is number of periodic SI windows. ‘W’ can be one or greater than one. If the SI request is received in Nth SI period, then requested SIB (or SI-message) is provided (i.e. transmitted) in SI window of ‘W’ SI periods starting from N+1th SI period. Alternately, if the SI request is received in Nth SI period, then requested SIB (or SI-message) is provided (i.e. transmitted) in ‘W’ SI windows starting from N+1th SI period. After sending the SI request at operation 120, UE monitors ‘W’ SI periods for receiving the requested SIB (or SI-message) at operation 140. For example, UE monitors the SI window of requested SIB (or SI-message) in ‘W’ SI periods of that SIB (or SI-message) starting from the SI period immediately next to SI period in which SI request is sent. Alternately, UE monitors the ‘W’ SI windows of requested SIB (or SI-message) starting from the SI period immediately next to SI period in which SI request is sent.

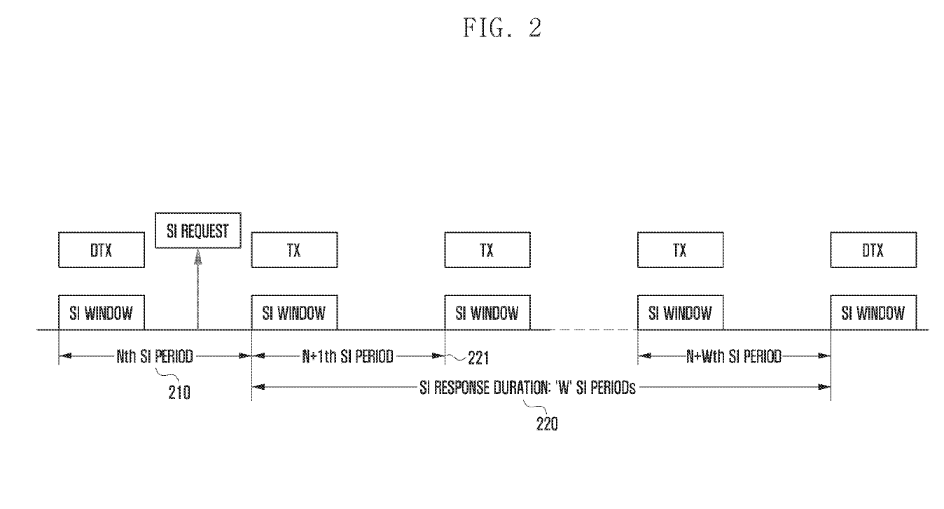

FIG. 2 illustrates monitoring SI periods for receiving the requested SI according to Embodiment 1 of the disclosure.

As shown in FIG. 2, if SI request is sent for a SIB (or a SI-message) in its Nth SI period (210), then UE monitors the SI window of requested SIB (or SI-message) in ‘W’ SI periods (220) of that SIB starting from N+1th SI period (221). SI window of SIB is the SI window of SI-message to which this SIB is mapped. Alternately, if SI request is sent for a SIB (or SI-message) in its Nth SI period (210), then UE monitors the ‘W’ SI windows (220) of requested SIB (or SI-message) starting from N+1th SI period (221).

The SI response duration (i.e. ‘W’ SI periods or ‘W’ SI windows wherein SI window occurs periodically every SI period) over which requested SIB (or SI-message) is provided (i.e. transmitted by network (i.e. gNB, eNB or BS)) after receiving the SI request is indicated in minimum SI (e.g. SIB 1) and/or in dedicated radio resource control (RRC) signaling. In other words, the SI response duration (i.e. ‘W’ SI periods or ‘W’ SI windows wherein SI window occurs periodically every SI period) over which requested SIB (or SI-message) is obtained (i.e. received by UE) after transmitting the SI request is indicated in minimum SI (e.g. SIB 1) and/or in dedicated RRC signaling. The duration i.e. ‘W’ can be signaled for each SIB or each SI message. Alternately it can be common for all SIBs or all SI messages.

In an alternate embodiment, SI response duration (i.e. ‘W’ SI periods or ‘W’ SI windows wherein SI window occurs periodically every SI period) can start from N+2th SI period instead of N+1th SI period (221) if SI request is sent in Nth SI period (210). After sending the SI request in Nth SI period (210), for receiving the requested SIB (or SI-message), UE monitors the SI window of requested SIB (or SI-message) in ‘W’ SI periods of that SIB (or SI-message) starting from N+2th SI period. Alternately, after sending the SI request in Nth SI period (210), for receiving the requested SIB (or SI-message), UE monitors the ‘W’ SI windows of requested SIB (or SI-message) starting from N+2th SI period.

In an alternate embodiment, SI response duration (i.e. ‘W’ SI periods or ‘W’ SI windows wherein SI window occurs periodically every SI period) can start from N+k^{th} SI period if SI request is sent in Nth SI period (210). Parameter ‘k’ can be predefined or signaled (e.g. in minimum SI i.e. SIB 1) or in dedicated RRC signaling by network (i.e. gNB, eNB or BS). After sending the SI request in Nth SI period (210), for receiving the requested SIB (or SI-message), UE monitors the SI window of requested SIB (or SI-message) in ‘W’ SI periods of that SIB (or SI-message) starting from N+kt SI period. Alternately, after sending the SI request in Nth SI period (210), for receiving the requested SIB (or SI-message), UE monitors ‘W’ SI windows of requested SIB (or SI-message) starting from N+kt SI period.

In another embodiment, SI response duration (i.e. ‘W’ SI periods or ‘W’ SI windows wherein SI window occurs periodically every SI period) can start from earliest SI period which starts at least X ms further away from the instant in which SI request is sent. X can be predefined or signaled by network in minimum SI (e.g. SIB 1) or in dedicated RRC signaling.

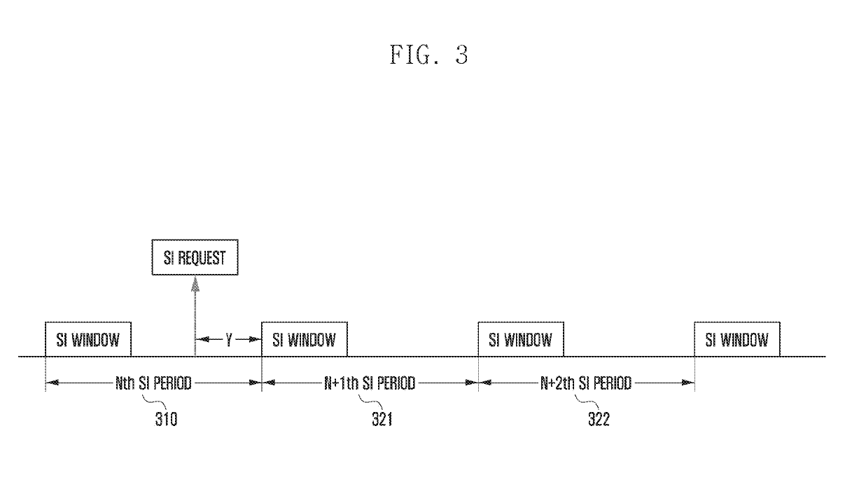

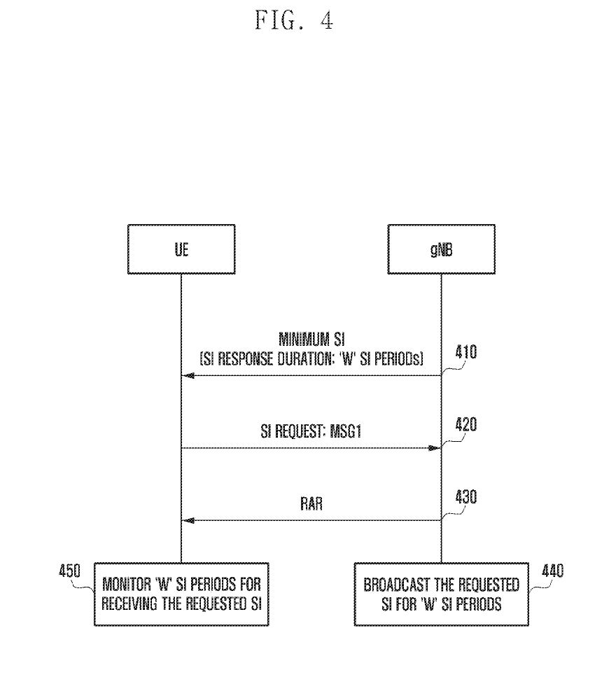

FIG. 3 illustrates monitoring SI periods for receiving the requested SI according to another embodiment of the disclosure.

Referring to FIG. 3, if duration ‘Y’ is greater than or equal to ‘X’ then SI response duration for SI request sent in Nth SI period (310) starts from N+1th SI period (321) i.e. UE monitors the SI window of requested SIB (or SI-message) in ‘W’ SI periods of that SIB (or SI-message) starting from N+1th SI period (321). If duration ‘Y’ is lesser than ‘X’ then SI response duration for SI request sent in Nth SI period (310) starts from N+2th SI period (322) i.e. UE monitors the SI window of requested SIB (or SI-message) in ‘W’ SI periods of that SIB (or SI-message) starting from N+2th SI period (322).

In another embodiment, SI response duration (i.e. ‘W’ SI periods or ‘W’ SI windows wherein SI window occurs periodically every SI period) can start from earliest SI window which starts at least X ms further away from the instant in which SI request is sent. X can be predefined or signaled by network in minimum SI (e.g. SIB1) or in dedicated RRC signaling. For example, in FIG. 3 below, if duration ‘Y’ is greater than or equal to ‘X’ then SI response duration for SI request sent in Nth SI period (310) starts from N+1th SI period (321) i.e. UE monitors the SI window of requested SIB (or SI-message) for ‘W’ SI windows of that SIB (or SI-message) starting from N+1th SI period (321). If duration ‘Y’ is lesser than ‘X’ then SI response duration for SI request sent in Nth SI period (310) starts from N+2th SI period (322) i.e. UE monitors the SI window of requested SIB (or SI-message) for ‘W’ SI windows of that SIB (or SI-message) starting from N+2th SI period (322).

If the SI response duration comprises of multiple SI periods then UE monitors SI window of first SI period in SI response duration. If the UE does not receive the requested SI then it monitors the next SI period and so on until the last SI period of SI response duration. If requested SI is not received after monitoring the last SI period of SI response duration (i.e. ‘W’ SI windows or ‘W’ SI periods) then UE can send the SI request again. In an embodiment, if requested SI is not received after monitoring the last SI period of SI response duration (i.e. ‘W’ SI windows or ‘W’ SI periods) then UE may send the SI request again after a predefined or configured time duration.

In an embodiment of the disclosure, network may indicate using an indicator that SIB (or SI-message) provided on demand is being broadcasted temporarily (the duration of broadcast can also be indicated). This indicator can be there for each SIB (or SI-message) which is provided on demand. This enables the other UEs which have not sent the request to obtain the SIB (or SI-message), to receive it without sending the SI request. For example, UE determines whether the SIB (or SI-message) is periodically broadcasted or provided on demand. UE determines this based on a first indicator in minimum SI (e.g. SIB 1). This first indicator can be there for each SIB (or SI-message). If the SIB is provided on demand, it then determines whether it is being broadcasted (temporarily) or not. UE determines this based on a second indicator in minimum SI (e.g. SIB 1). This second indicator can be there for each SIB (or SI-message). If the first indicator in minimum SI indicates that SIB (or SI-message) is provided on demand and the second indicator in minimum SI indicates that SIB (or SI-message) is being broadcasted then UE does not send SI request and obtain the SIB (or SI-message) from broadcast using the scheduling information (e.g. SI period, SI window and broadcast duration). If the first indicator in minimum SI indicates that SIB (or SI-message) is provided on demand and the second indicator in minimum SI indicates that SIB (or SI-message) is not broadcasted then UE sends the SI request.

### Embodiment 1A

The scheduling information for other SI (consists of one or more SIBs) includes SIB type, validity information, SI periodicity, SI window information in minimum SI (e.g. SIB1) irrespective of whether other SI is periodically broadcasted or provided on demand. One or more SIB type can be mapped to SI-message broadcasted during the SI window which occurs with a certain periodicity.

FIG. 4 illustrates an SI response reception according to Embodiment 1A of the disclosure.

As shown in FIG. 4, gNB (or eNB or BS) transmits minimum SI to UE at operation 410. If the minimum SI indicates that a SIB (or SI-message) is provided on demand, then the UE does not assume that this SIB (or SI-message) is broadcasted in its SI window every SI-Period and therefore the UE sends an SI request to receive this SIB (or SI-message) at operation 420. SI window of SIB is the SI window of SI-message to which this SIB is mapped.

If the SI request is received by gNB then the requested SIB (or SI-message) is provided (i.e. transmitted) in SI window of ‘W’ SI periods at operation 440. In other words, SIB (or SI-message) is provided in ‘W’ SI windows wherein SI window occurs every SI period. The SI period is the periodicity of SI message carrying this SIB. SI message is transmitted in SI window of SI period. The information on the SI window and SI period for an SI message may be signaled by network in minimum SI (e.g. SIB 1) at operation 410. ‘W’ is number of SI periods. Alternately W is number of periodic SI windows. ‘W’ can be one or greater than one.

Meanwhile, after receiving the SI request, network (i.e. gNB, eNB or BS) sends an acknowledgment indicating SI request is received. As shown in FIG. 4, in case SI request is indicated using MSG1 i.e. physical random access channel (PRACH) preamble transmission at operation 420, gNB sends, at operation 430, an acknowledgment i.e. random access (RA) response (RAR) indicating reception of PRACH preamble indicating SI request.

In an embodiment RAR acknowledging SI request is successfully received if the RAR corresponds to both PRACH resource and random access preamble identifier (RAPID) used by UE for PRACH preamble transmission i.e. RAR is successfully received if UE receives a physical downlink control channel (PDCCH) addressed to its random access-radio network temporary identifier (RA-RNTI) and decoded transport block (e.g. media access control (MAC) packet data unit (PDU)) includes RAR carrying RAPID. PDCCH for RAR is addressed to RA-RNTI wherein RA-RNTI is specific to PRACH resource and RAPID is included in RAR MAC PDU.

In another embodiment RAR acknowledging SI request is successfully received if the RAR corresponds to RAPID of PRACH preamble transmitted by it i.e. RAR is successfully received if UE receives a PDCCH addressed to its RA-RNTI or a reserved RA-RNTI, and decoded transport block (e.g. MAC PDU) includes RAR carrying RAPID. This is the case when PRACH preamble identifies a particular SI request i.e. request for a specific SIB or set of SIBs.

In another embodiment RAR is successfully received if the RAR corresponds to PRACH resource used by UE for PRACH preamble transmission i.e. RAR is successfully received if UE receives a PDCCH addressed to its RA-RNTI. This is the case when PRACH resource identifies a particular SI request i.e. request for a specific SIB or set of SIBs.

In an embodiment of the disclosure, RAR may include which SIBs or SI-message(s) are transmitted by network (i.e. gNB, eNB or BS) or for which SIB(s) or SI-message(s) network (i.e. gNB, eNB or BS) has received the SI request. RAR may include at least one of one or more SIB IDs, one or more SIB types, or SIB bitmap (each bit in bitmap corresponds to a SIB, bit can be set to one if network has received request for that SIB and/or network will transmit that SIB) to indicate the same. This information is useful as it may also indicate the SIB(s) which UE has not yet requested but are being transmitted based on other UE's request. Thus, UE can avoid sending a request for such SIB(s). Network may also include scheduling information on SIB(s) in RAR. RAR corresponding to PRACH transmission indicating SI request may include RAPID. Other information such as timing advance, C-RNTI, etc. are not needed.

In an embodiment of the disclosure, RA-RNTI for receiving RAR for PRACH preamble transmission indicating SI request can be a common or reserved RNTI (predefined or indicated in minimum system information (MSI)). UE monitors for PDCCH addressed to this RA-RNTI in RAR window. If UE receives RAR scheduled using PDCCH addressed to reserve RA-RNTI, UE can stop monitoring RAR in RAR window and consider RAR reception as successful. Alternately, if UE receives RAR scheduled using PDCCH addressed to reserve RA-RNTI and RAR includes RAPID of RACH preamble transmitted by UE or indicates that SIB(s) which UE has requested will be transmitted or network has received the request for them, UE can stop monitoring RAR in RAR window and consider RAR reception as successful.

In an embodiment UE may monitor for PDCCH addressed to reserved or common RA-RNTI and RA-RNTI corresponding to PRACH resource in which UE has transmitted the PRACH preamble. If UE receives RAR scheduled using PDCCH addressed to reserve RA-RNTI and it indicates that SIB(s) which UE has requested will be transmitted or network has received the request for them then UE can stop monitoring RAR in RAR window and consider RAR reception as successful. If UE receives RAR scheduled using PDCCH addressed to reserve RA-RNTI and it does not indicate that SIB(s) which UE has requested will be transmitted or network has received the request for them then UE continue to monitor RAR in RAR window. If UE receives RAR scheduled using PDCCH addressed to RA-RNTI corresponding to PRACH resource in which UE has transmitted the PRACH preamble and RAPID is included in RAR then UE can stop monitoring RAR in RAR window and consider RAR reception as successful.

In an embodiment if UE receives RAR scheduled using PDCCH addressed to its RA-RNTI and it indicates at least the SIB(s) or SI-message(s) which UE has requested will be transmitted or network has received the request for them, then UE can stop monitoring RAR in RAR window and consider RAR reception as successful. Note that RAR may include SIB(s) or SI-message(s) which the UE has not requested as well.

If RAR acknowledging SI request is successfully received in Nth SI period, then requested SIB (or SI-message) is obtained (i.e. received) by UE in SI window of ‘W’ SI periods starting from N+1th SI period. Alternately, if the RAR acknowledging SI request is successfully received in Nth SI period, then requested SIB (or SI-message) is obtained (i.e. received) by UE in ‘W’ SI windows starting from N+1th SI period. After receiving the RAR acknowledging SI request successfully at operation 430, UE monitors ‘W’ SI periods for receiving the requested SIB (or SI-message) at operation 450. For example, UE monitors the SI window of requested SIB (or SI-message) in ‘W’ SI periods of that SIB (or SI-message) starting from the SI period immediately next to SI period in which RAR acknowledging SI request is received. Alternately, UE monitors the ‘W’ SI windows of requested SIB (or SI-message) starting from the SI period immediately next to SI period in which RAR acknowledging SI request is received.

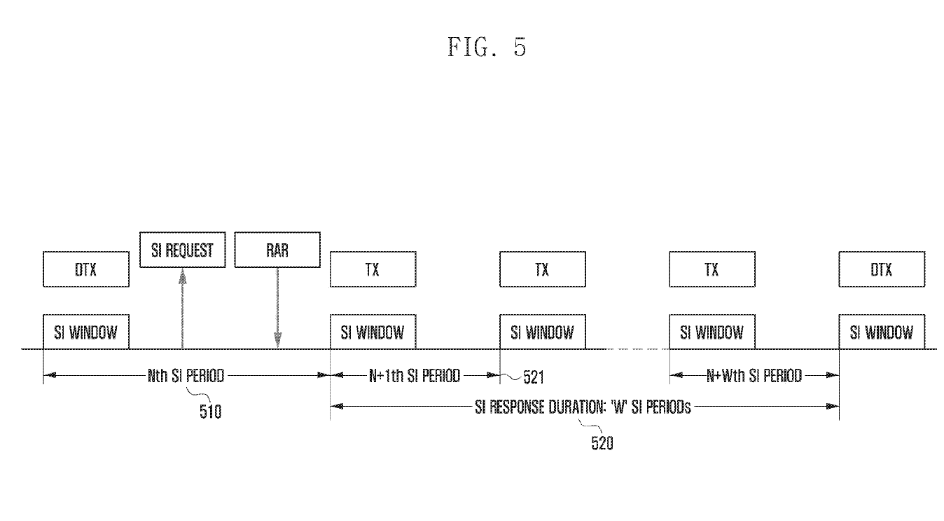

FIG. 5 illustrates monitoring SI periods for receiving the requested SI according to Embodiment 1A of the disclosure.

As shown in FIG. 5, if RAR acknowledging SI request is received in Nth SI period (510), then UE monitors the SI window of requested SIB (or SI-message) in ‘W’ SI periods (520) of that SIB (or SI-message) starting from N+1th SI period (521). Alternately, if RAR acknowledging SI request is received in Nth SI period (510), then UE monitors the W SI windows (520) of requested SIB (or SI-message) starting from N+1th SI period (521).

The SI response duration (i.e. ‘W’ SI periods or W SI windows wherein SI window occurs periodically every SI period) over which requested SIB is provided (i.e. transmitted) by gNB, eNB or BS after receiving the request is indicated in minimum SI (e.g. SIB1), in dedicated RRC signaling and/or in RAR. In other words, the SI response duration (i.e. ‘W’ SI periods or ‘W’ SI windows wherein SI window occurs periodically every SI period) over which requested SIB (or SI-message) is obtained (i.e. received by UE) after transmitting the SI request is indicated in minimum SI (e.g. SIB 1) and/or in dedicated RRC signaling or in RAR. The duration i.e. ‘W’ can be signaled for each SIB or each SI message. Alternately it can be common for all SIBs or all SI messages.

In an alternate embodiment, SI response duration (i.e. ‘W’ SI periods or ‘W’ SI windows wherein SI window occurs periodically every SI period) can start from N+2th SI period instead of N+1th SI period (521) if RAR acknowledging SI request is received in Nth SI period (510). After receiving the RAR acknowledging SI request in Nth SI period (510), for receiving the requested SIB (or SI-message), UE monitors the SI window of requested SIB (or SI-message) in ‘W’ SI periods of that SIB (or SI-message) starting from N+2th SI period. Alternately, after receiving the RAR acknowledging SI request in Nth SI period (510), for receiving the requested SIB (or SI-message), UE monitors the ‘W’ SI windows of requested SIB (or SI-message) starting from N+2th SI period.

In an alternate embodiment, SI response duration (i.e. ‘W’ SI periods or ‘W’ SI windows wherein SI window occurs periodically every SI period) can start from N+kth SI period if RAR acknowledging SI request is received in Nth SI period (510). Parameter ‘k’ can be predefined or signaled (e.g. in minimum SI (e.g. SIB 1) or in RAR) or in dedicated RRC signaling by network (e.g. gNB, eNB or BS). After receiving the RAR acknowledging SI request in Nth SI period (510), for receiving the requested SIB (or SI-message), UE monitors the SI window of requested SIB (or SI-message) in ‘W’ SI periods of that SIB (or SI-message) starting from N+k^{th} SI period. Alternately, after receiving the RAR acknowledging SI request in Nth SI period (510), for receiving the requested SIB (or SI-message), UE monitors W SI windows of requested SIB (or SI-message) starting from N+k^{th} SI period.

In another embodiment, SI response duration (i.e. ‘W’ SI periods or W SI windows wherein SI window occurs periodically every SI period) can start from earliest SI period which starts at least X ms further away from the instant in which SI request is sent. X can be predefined or signaled by network in minimum SI (e.g. SIB 1), in dedicated RRC signaling or in RAR. In an embodiment X can be time interval between SI request transmission and RAR reception. For example, in FIG. 3, if duration ‘Y’ is greater than or equal to ‘X’ then SI response duration for SI request sent in Nth SI period (310) starts from N+1th SI period (321) i.e. UE monitors the SI window of requested SIB (or SI-message) in ‘W’ SI periods of that SIB (or SI-message) starting from N+1th SI period (321). If duration ‘Y’ is lesser than ‘X’ then SI response duration for SI request sent in Nth SI period (310) starts from N+2th SI period (322) i.e. UE monitors the SI window of requested SIB (or SI-message) in ‘W’ SI periods of that SIB (or SI-message) starting from N+2th SI period (322).

In another embodiment, SI response duration (i.e. ‘W’ SI periods or W SI windows wherein SI window occurs periodically every SI period) can start from earliest SI window which starts at least X ms further away from the instant in which SI request is sent. X can be predefined or signaled by network in minimum SI (e.g. SIB 1), in dedicated RRC signaling or in RAR. In an embodiment X can be time interval between SI request transmission and RAR reception. For example, in FIG. 3, if duration ‘Y’ is greater than or equal to ‘X’ then SI response duration for SI request sent in Nth SI period (310) starts from N+1th SI period (321) i.e. UE monitors the SI window of requested SIB (or SI-message) for ‘W’ SI windows of that SIB (or SI-message) starting from N+1th SI period (321). If duration ‘Y’ is lesser than ‘X’ then SI response duration for SI request sent in Nth SI period (310) starts from N+2th SI period (322) i.e. UE monitors the SI window of requested SIB (or SI-message) for W′ SI windows of that SIB (or SI-message) starting from N+2th SI period (322).

In another embodiment, SI response duration (i.e. ‘W’ SI periods or W SI windows wherein SI window occurs periodically every SI period) can start from earliest SI period which starts at least X ms further away from the instant in which RAR acknowledging SI request is received. X can be predefined or signaled by network in minimum SI, in dedicated signaling or in RAR.

In another embodiment, SI response duration (i.e. ‘W’ SI periods or W SI windows wherein SI window occurs periodically every SI period) can start from earliest SI window which starts at least X ms further away from the instant in which RAR acknowledging SI request is received. X can be predefined or signaled by network in minimum SI, in dedicated signaling or in RAR.

If the SI response duration (i.e. ‘W’ SI periods or W SI windows wherein SI window occurs periodically every SI period) comprises of multiple SI periods then UE monitors SI window of first SI period in SI response duration. If does not receive the requested SI then it monitors the next SI period and so on until the last SI period of SI response duration. If requested SI is not received after monitoring the last SI period of SI response duration (i.e. W SI windows or W SI periods) then UE can send the SI request again. In an embodiment, if requested SI is not received after monitoring the last SI period of SI response duration (i.e. ‘W’ SI windows or ‘W’ SI periods) then UE may send the SI request again after a predefined or configured time duration.

In an embodiment of the disclosure, network may indicate using an indicator that SIB (or SI-message) provided on demand is being broadcasted temporarily (the duration of broadcast can also be indicated). This indicator can be there for each SIB (or SI-message) which is provided on demand. This enables the other UEs which have not sent the request to obtain the SIB (or SI-message), to receive it without sending the SI request. For example, UE determines whether the SIB (or SI-message) is periodically broadcasted or provided on demand. UE determines this based on a first indicator in minimum SI (e.g. SIB 1). This indicator can be there for each SIB (or SI-message). If the SIB (or SI-message) is provided on demand, it then determines whether it is being broadcasted (temporarily) or not. UE determines this based on a second indicator in minimum SI (e.g. SIB 1). This second indicator can be there for each SIB (or SI-message). If the first indicator in minimum SI indicates that SIB (or SI-message) is provided on demand and the second indicator in minimum SI indicates that SIB (or SI-message) is broadcasted then UE does not send SI request and obtain the SIB (SI-message) from broadcast using the scheduling information (e.g. SI period, SI window and broadcast duration). If the first indicator in minimum SI indicates that SIB (or SI-message) is provided on demand and the second indicator in minimum SI indicates that SIB (or SI-message) is not broadcasted then UE sends the SI request.

### Embodiment 1B

The scheduling information for other SI includes SIB type, validity information, SI periodicity, SI-window information in minimum SI (e.g. SIB 1) irrespective of whether other SI (consists of one or more SIBs) is periodically broadcasted or provided on demand. One or more SIB type can be mapped to SI-message broadcasted during the SI-window which occurs with a certain periodicity.

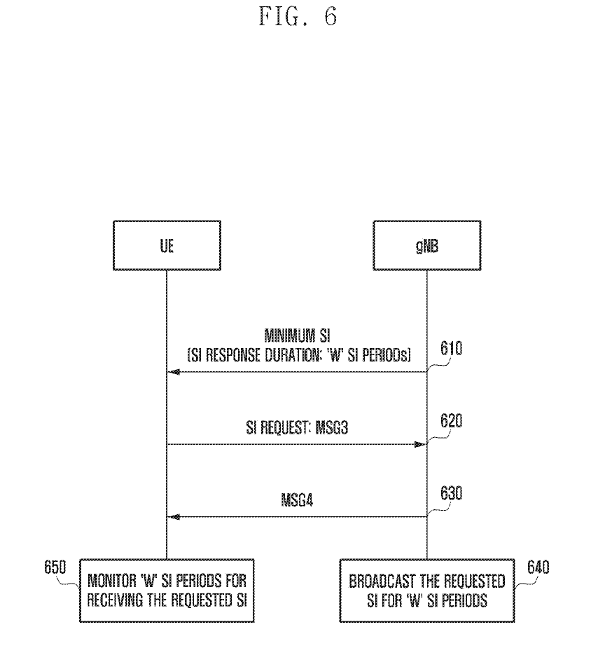

FIG. 6 illustrates an SI response reception according to Embodiment 1B of the disclosure.

As shown in FIG. 6, gNB (or eNB or BS) transmits minimum SI to UE at operation 610. If the minimum SI indicates that a SIB (or SI-message) is provided on demand, then the UE does not assume that this SIB (or SI-message) is broadcasted in its SI-Window every SI-Period and therefore the UE sends an SI request to receive this SIB (or SI-message) at operation 620. SI window of SIB is the SI window of SI-message to which this SIB is mapped.

If the SI request is received by gNB then the requested SIB (or SI-message) is provided (i.e. transmitted) in SI window of ‘W’ SI periods at operation 640. In other words, SIB (or SI-message) is provided in ‘W’ SI windows wherein SI window occurs every SI period. The SI period is the periodicity of SI message carrying this SIB. SI message is transmitted in SI window of SI period. The information on the SI window and SI period for an SI message may be signaled by network in minimum SI (e.g. SIB 1) at operation 610. ‘W’ is number of SI periods. Alternately ‘W’ is number of periodic SI windows. ‘W’ can be one or greater than one.

Meanwhile, after receiving the SI request, network (i.e. gNB, eNB or BS) sends an acknowledgment indicating SI request is received. As shown in FIG. 6, in case SI request is indicated using MSG3, gNB sends, at operation 630, an acknowledgement i.e. MSG4 indicating reception of SI request. UE first transmits PRACH preamble and receives an RAR in response. MSG3 is the MAC PDU transmitted by UE using the UL grant received in RAR. SI request transmitted in MSG3 can be a SI request RRC message or a CCCH SDU. UE identity is included in this SI request RRC message transmitted in MSG3. In an alternate embodiment, SI request transmitted in MSG3 can be a MAC CE for SI request. UE identity is not included in this SI request MAC CE transmitted in MSG3. In an embodiment of the disclosure, MSG4 may include which SIB(s) or SI-message(s) are transmitted by network or for which network has received SI request. MSG4 may include at least one of one or more SIB IDs, one or more SIB types or SIB or SI message bitmap (each bit in bitmap corresponds to a SIB (or SI-message), bit can be set to one if network has received request for that SIB and/or network will transmit that SIB (or SI-message)) to indicate the same. This information is useful as it may also indicate the SIB(s) or SI-message(s) which UE has not yet requested but are being transmitted based on another UE's request. Thus, UE can avoid sending a request for such SIB(s) or SI-message(s). Network may also include scheduling information on SIB(s) or SI-message(s) in MSG4. For receiving MSG4 UE monitor for PDCCH addressed to its cell-RNTI (C-RNTI) or a reserve RNTI reserved for SI purpose. UE considers contention resolution (or MSG4 reception) as successful if it receives PDCCH addressed to its RNTI (C-RNTI or reserved RNTI) and at least the requested SIB(s) are included in decoded transport block (TB) (or MAC PDU). In another embodiment, UE considers contention resolution (or MSG4 reception) as successful if it receives PDCCH addressed to its C-RNTI and ‘X’ bits of common control channel (CCCH) service data unit (SDU) (CCCH SDU includes SI request message) transmitted by UE in MSG3 is received in decoded TB (or MAC PDU). In another embodiment, UE considers contention resolution as successful if it receives PDCCH addressed to its C-RNTI and at least the requested SIB(s) or SI message(s) are included in decoded TB (or MAC PDU). In another embodiment, UE considers contention resolution (or MSG4 reception) as successful if it receives PDCCH addressed to its C-RNTI and its UE ID (e.g. system architecture evolution (SAE)-temporary mobile subscriber identity (TMSI) (S-TMSI)) transmitted in MSG3 is received in decoded TB (or MAC PDU). In another embodiment, UE considers contention resolution (or MSG4 reception) as successful if it receives PDCCH addressed to its C-RNTI and SI ACK MAC CE is received in decoded TB (or MAC PDU). The requested SIB(s) or SI message(s) can be included in SI ACK MAC CE.

If the MSG4 or acknowledgment for SI request is received in Nth SI period, then requested SIB (or SI-message) is obtained (i.e. received) by UE in SI window of ‘W’ SI periods starting from N+1th SI period. Alternately, if the MSG4 or acknowledgment for SI request is received in Nth SI period, then requested SIB (or SI-message) is obtained (i.e. received) in ‘W’ SI windows starting from N+1th SI period. After receiving the MSG4 or acknowledgment for SI request at operation 630, UE monitors ‘W’ SI periods for receiving the requested SIB (or SI-message) at operation 650. For example, UE monitors the SI window of requested SIB (or SI-message) in ‘W’ SI periods of that SIB (or SI-message) starting from the SI period immediately next to SI period in which MSG4 is received. Alternately, UE monitors the W SI windows of requested SIB (or SI-message) starting from the SI period immediately next to SI period in which MSG4 or acknowledgment for SI request is received.

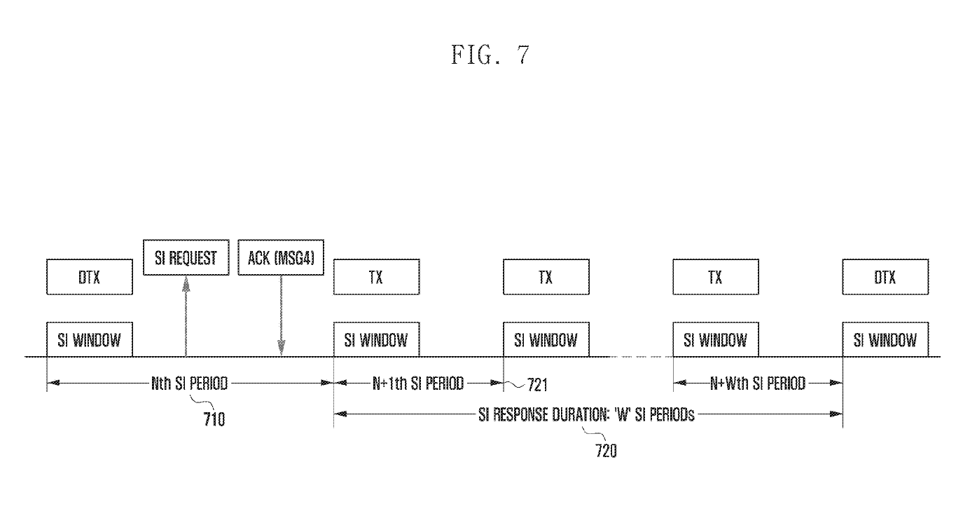

FIG. 7 illustrates monitoring SI periods for receiving the requested SI according to Embodiment 1B of the disclosure.

As shown in FIG. 7, if MSG4 or acknowledgment for SI request is received in Nth SI period (710), then UE monitors the SI window of requested SIB (or SI-message) in ‘W’ SI periods (720) of that SIB (or SI-message) starting from N+1th SI period (721). Alternately, if MSG4 or acknowledgment for SI request is received in Nth SI period (710), then UE monitors the ‘W’ SI windows of requested SIB (or SI-message) starting from N+1th SI period (721).

The SI response duration (i.e. ‘W’ SI periods or W SI windows wherein SI window occurs periodically every SI period) over which requested SIB (or SI-message) is provided (i.e. transmitted) by gNB, eNB or BS after receiving the request is indicated in minimum SI (e.g. SIB 1), in dedicated RRC signaling and/or in MSG4 or acknowledgment for SI request. In other words, the SI response duration (i.e. ‘W’ SI periods or ‘W’ SI windows wherein SI window occurs periodically every SI period) over which requested SIB (or SI-message) is obtained (i.e. received by UE) after transmitting the SI request is indicated in minimum SI (e.g. SIB 1) and/or in dedicated RRC signaling or in MSG4 or acknowledgment for SI request. The duration i.e. ‘W’ can be signaled for each SIB or each SI message. Alternately it can be common for all SIBs or all SI messages.

In an alternate embodiment, SI response duration (i.e. ‘W’ SI periods or W SI windows wherein SI window occurs periodically every SI period) can start from N+2th SI period instead of N+1th SI period (721) if MSG4 or acknowledgment for SI request is received in Nth SI period (710). After receiving the MSG4 or acknowledgment for SI request in Nth SI period (710), for receiving the requested SIB (or SI-message), UE monitors the SI window of requested SIB (or SI-message) in ‘W’ SI periods of that SIB (or SI-message) starting from N+2th SI period. Alternately, after receiving the MSG4 or acknowledgment for SI request in Nth SI period (710), for receiving the requested SIB (or SI-message), UE monitors the W SI windows of requested SIB (or SI-message) starting from N+2th SI period.

In an alternate embodiment, SI response duration (i.e. ‘W’ SI periods or W SI windows wherein SI window occurs periodically every SI period) can start from N+kth SI period if MSG4 or acknowledgment for SI request is received in Nth SI period (710). Parameter ‘k’ can be predefined or signaled (e.g. in minimum SI (e.g. SIB1), or in MSG4) or in dedicated RRC signaling by network. After receiving the MSG4 or acknowledgment for SI request in Nth SI period (710), for receiving the requested SIB (or SI-message), UE monitors the SI window of requested SIB (or SI-message) in ‘W’ SI periods of that SIB (or SI-message) starting from N+k^{th} SI period. Alternately, after receiving the MSG4 or acknowledgment for SI request in Nth SI period (710), for receiving the requested SIB (or SI-message), UE monitors W SI windows of requested SIB (or SI-message) starting from N+kt SI period.

In another embodiment, SI response duration (i.e. ‘W’ SI periods or W SI windows wherein SI window occurs periodically every SI period) can start from earliest SI period which starts at least X ms further away from the instant in which SI request is sent. X can be predefined or signaled by network in minimum SI (e.g. SIB1), in dedicated signaling or in MSG4 or acknowledgment for SI request. In an embodiment X can be time interval between SI request transmission and MSG4 or acknowledgment for SI request reception. For example, in FIG. 3, if duration ‘Y’ is greater than or equal to ‘X’ then SI response duration for SI request sent in Nth SI period (310) starts from N+1th SI period (321) i.e. UE monitors the SI window of requested SIB (or SI-message) in ‘W’ SI periods of that SIB (or SI-message) starting from N+1th SI period (321). If duration ‘Y’ is lesser than ‘X’ then SI response duration for SI request sent in Nth SI period (310) starts from N+2th SI period (322) i.e. UE monitors the SI window of requested SIB (or SI-message) in ‘W’ SI periods of that SIB (or SI-message) starting from N+2th SI period (322).

In another embodiment, SI response duration (i.e. ‘W’ SI periods or W SI windows wherein SI window occurs periodically every SI period) can start from earliest SI window which starts at least X ms further away from the instant in which SI request is sent. X can be predefined or signaled by network in minimum SI, in dedicated signaling or in MSG4 or acknowledgment for SI request. In an embodiment X can be time interval between SI request transmission and MSG4 or acknowledgment for SI request reception. For example, in FIG. 3, if duration ‘Y’ is greater than or equal to ‘X’ then SI response duration for SI request sent in Nth SI period (310) starts from N+1th SI period (321) i.e. UE monitors the SI window of requested SIB (or SI-message) for ‘W’ SI windows of that SIB (or SI-message) starting from N+1th SI period (321). If duration ‘Y’ is lesser than ‘X’ then SI response duration for SI request sent in Nth SI period (310) starts from N+2th SI period (322) i.e. UE monitors the SI window of requested SIB (or SI-message) for ‘W’ SI windows of that SIB (or SI-message) starting from N+2th SI period (322).

In another embodiment, SI response duration (i.e. ‘W’ SI periods or W SI windows wherein SI window occurs periodically every SI period) can start from earliest SI period which starts at least X ms further away from the instant in which MSG4 or acknowledgment for SI request is received. X can be predefined or signaled by network in minimum SI, in dedicated signaling or in MSG4 or acknowledgment for SI request.

In another embodiment, SI response duration (i.e. ‘W’ SI periods or W SI windows wherein SI window occurs periodically every SI period) can start from earliest SI window which starts at least X ms further away from the instant in which MSG4 or acknowledgment for SI request is received. X can be predefined or signaled by network in minimum SI, in dedicated signaling or in MSG4 or acknowledgment for SI request.

If the SI response duration (i.e. ‘W’ SI periods or W SI windows wherein SI window occurs periodically every SI period) comprises of multiple SI periods then UE monitors SI window of first SI period in SI response duration. If does not receive the requested SI then it monitors the next SI period and so on until the last SI period of SI response duration. In an embodiment, if requested SI is not received after monitoring the last SI period of SI response duration (i.e. W SI windows or W SI periods) then UE can send the SI request again. In an alternate embodiment, if requested SI is not received after monitoring the last SI period of SI response duration (i.e. ‘W’ SI windows or ‘W’ SI periods) then UE may send the SI request again after a predefined or configured time duration.

In an embodiment of the disclosure, network may indicate using an indicator that SIB (or SI-message) provided on demand is being broadcasted temporarily (the duration of broadcast can also be indicated). This indicator can be there for each SIB which (or SI-message) is provided on demand. This enables the other UEs which have not sent the request to obtain the SIB (or SI-message), to receive it without sending the SI request. For example, UE determines whether the SIB (or SI-message) is periodically broadcasted or provided on demand. UE determines this based on a first indicator in minimum SI (e.g. SIB1). This indicator can be there for each SIB (or SI-message). If the SIB (or SI-message) is provided on demand, it then determines whether it is being broadcasted (temporarily) or not. UE determines this based on a second indicator in minimum SI (e.g. SIB1). This second indicator can be there for each SIB (or SI-message). If the first indicator in minimum SI indicates that SIB (or SI-message) is provided on demand and the second indicator in minimum SI indicates that SIB (or SI-message) is broadcasted then UE does not send SI request and obtain the SIB from broadcast using the scheduling information (e.g. SI period, SI window and broadcast duration). If the first indicator in minimum SI indicates that SIB (or SI-message) is provided on demand and the second indicator in minimum SI indicates that SIB (or SI-message) is not broadcasted then UE sends the SI request.

### Embodiment 2

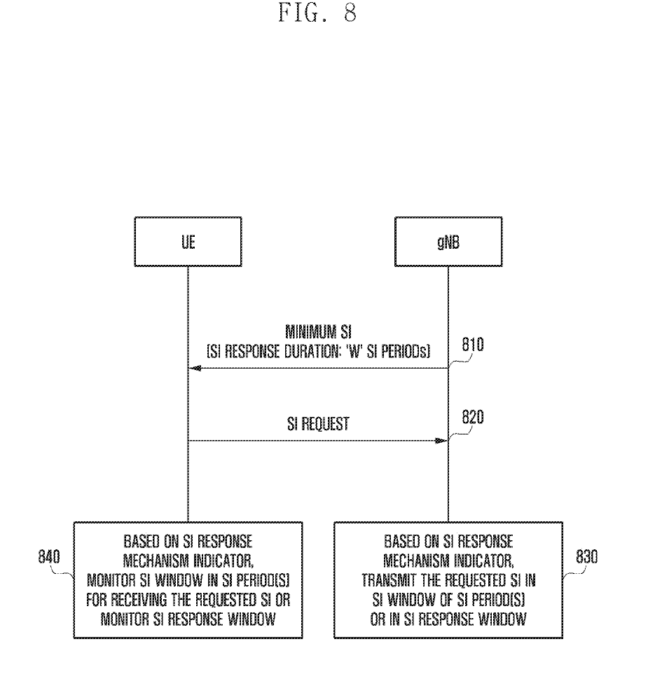

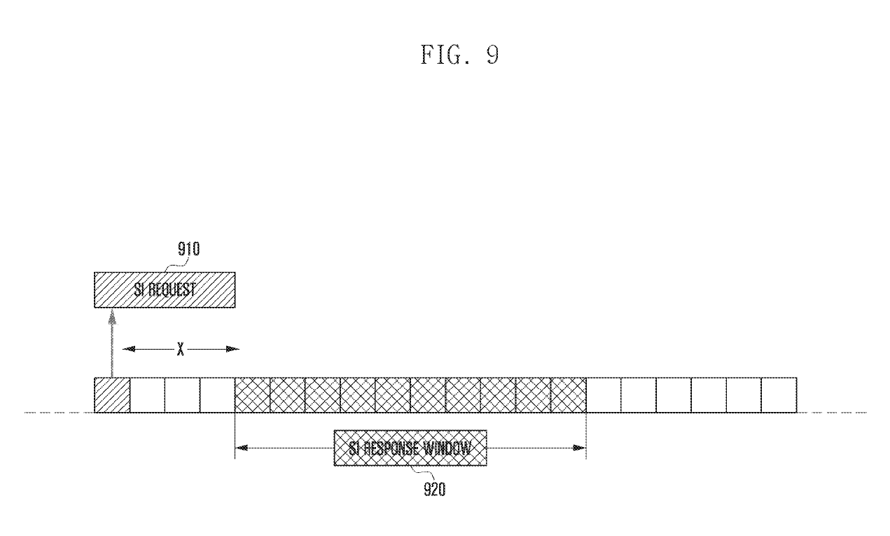

FIG. 8 illustrates an SI response reception according to Embodiment 2 of the disclosure. FIG. 9 illustrates that requested SI is provided in SI response window which starts at x ms from the SI request.

Referring to FIG. 8, gNB transmits an SI response mechanism indicator in minimum SI (e.g. SIB 1) to UE at operation 810. Specifically, network (e.g. gNB, eNB or BS) indicates in minimum SI (e.g. SIB 1) or in dedicated RRC signaling whether requested SI is provided based on scheduling framework i.e. in SI window of one or more SI periods (as explained in Embodiment 1) of requested SI or is provided independent of scheduling framework i.e. is provided in SI response window (920) which starts at x ms from the SI request (910) (as shown in FIG. 9). X can be predefined or signaled by network in minimum SI (e.g. SIB 1) or in dedicated RRC signaling. This indication can be explicit (e.g. by providing the SI response window parameters). Alternately, absence of scheduling information such as SI period, SI window etc. for SI which are provided on demand indicates that this SI after sending SI request, is provided independent of scheduling framework i.e. is provided in SI response window (920) which starts at x ms from the SI request (910). The length of SI response window (920) can be provided in MSI (e.g. SIB 1), can be pre-defined or can be provided in dedicated RRC signaling.

The UE transmits an SI request to the gNB at operation 820. Based on the SI response mechanism indicator in minimum SI (e.g. SIB 1), the gNB transmits the requested SI in SI window of SI period(s) or in SI response window at operation 830 and the UE monitors the SI window of SI period(s) for receiving the requested SI or the SI response window at operation 840.

### Embodiment 3

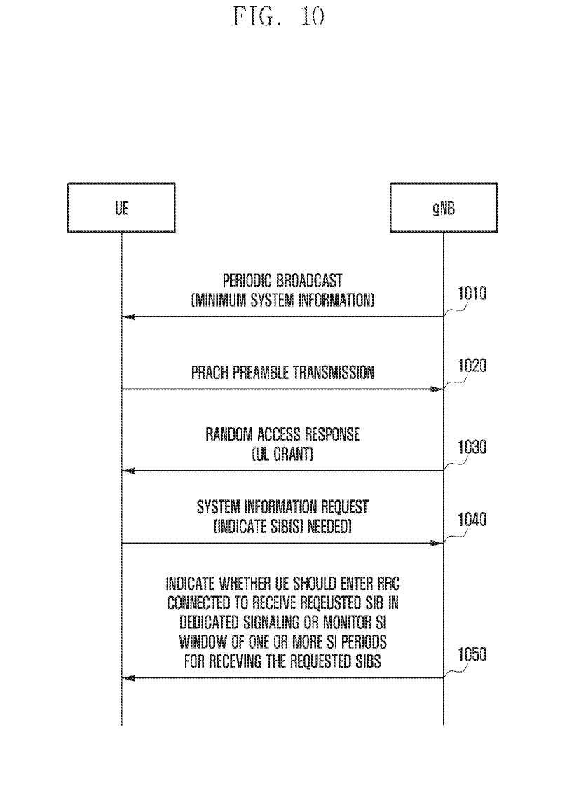

FIG. 10 illustrates an SI response reception according to Embodiment 3 of the disclosure.

Referring to FIG. 10, gNB broadcasts MSI (e.g. SIB 1) at operation 1010. The MSI (e.g. SIB 1) may be broadcasted periodically. After receiving the MSI (e.g. SIB 1), UE transmits a PRACH preamble (i.e. MSG1) at operation 1020. In response to the PRACH preamble (i.e. MSG1), the gNB transmits a random access response (i.e. MSG2) including UL grant at operation 1030.

In addition, in this method as shown in FIG. 10, the UE sends SI request using MSG3 (SI request RRC message or SI request MAC control element (CE)) at operation 1040 i.e. in the UL grant received in the random access response (i.e. MSG2). In one embodiment, in case UE is in idle state, at least one of UE identity (such as S-TMSI), indication of needed SIBs (i.e. list of SIB types or bitmap) or indication of needed SI messages (i.e. list of SI message types or bitmap) is included in SI request. UE identity may not be included if SI request is a MAC CE. In case UE is in inactive state, at least one of UE's resume identity, resume MAC_I, indication of needed SIBs (i.e. list of SIB types or bitmap) or indication of needed SI messages (i.e. list of SI message types or bit map) is included in SI request. In response gNB indicates whether UE should enter RRC connected state to receive requested SIBs or SI message(s) through dedicated signaling or UE should monitor SI window of one or more SI periods for receiving the requested SIBs or SI message(s) (i.e. network indicates that request SIBs are broadcasted as explained in Embodiment 1. No need to enter connected) at operation 1050.

In an embodiment the indication in MSG4 can be an explicit indication i.e. flag to enter RRC connected state or stay in IDLE/INACTIVE state. In alternative embodiment the indication in MSG4 can be an implicit indication in the form of allocating C-RNTI to the UE which indicates UE needs to enter RRC connected state. If C-RNTI is not allocated then UE remains in IDLE/INACTIVE state and monitors the SI window of one or more SI periods for receiving the requested SIB(s) using the SI-RNTI. Based on the implicit/explicit indication to enter the RRC connected state, UE monitors the scheduling channel to receive the requested SIB(s) using the allocated C-RNTI. While transmitting MSG3 for requesting SIB(s) or SI message(s) UE may include UE ID which is echoed back in MSG4 for contention resolution. If UE receives MSG4 including only the UE ID for contention resolution and does not receive the flag or C-RNTI then it is implicit indication for UE to monitor SI window of one or more SI periods for receiving the requested SIB(s).

In an embodiment, MSG4 may include connection setup message or connection resume accept message indicating UE to enter RRC connected state. If MSG4 does not include connection setup message or connection resume accept message indicating UE to enter RRC connected state, UE monitor SI window of one or more SI periods for receiving the requested SIB(s) or SI message(s).

The method shown in FIG. 10, gives full flexibility to the network to decide to deliver the requested SIB(s) or SI message(s) either in broadcast manner or UE dedicated manner. For delivery of the requested SIB(s) or SI message(s) since the UE is moved to RRC connected state, the UE dedicated signaling is subjected to link adaptation and hence resource efficient.

### Embodiment 4

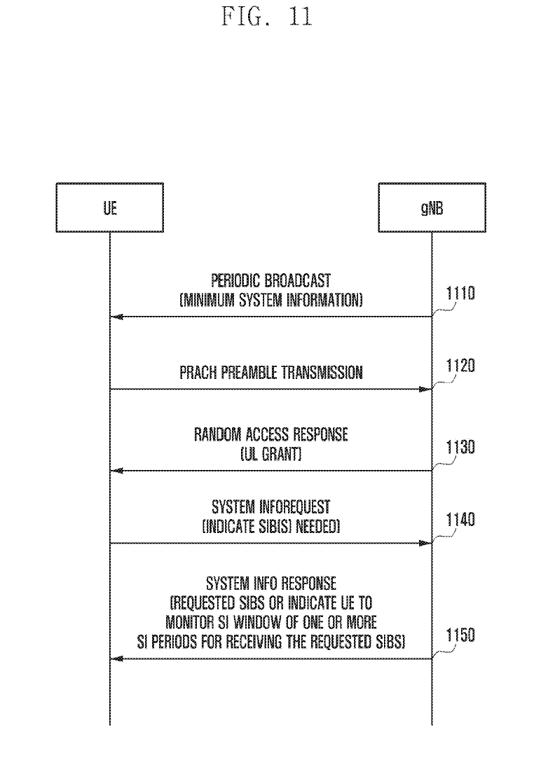

FIG. 11 illustrates an SI response reception according to Embodiment 4 of the disclosure.

Referring to FIG. 11, gNB broadcasts MSI (e.g. SIB 1) at operation 1110. The MSI (e.g. SIB 1) may be broadcasted periodically. After receiving the MSI (e.g. SIB 1), UE transmits a PRACH preamble (i.e. MSG1) at operation 1120. In response to the PRACH preamble (i.e. MSG1), the gNB transmits a random access response (i.e. MSG2) including UL grant at operation 1130.

In addition, in this method as shown in FIG. 11, the UE sends SI request (includes requested SIB(s) or SI message(s)) using MSG3 at operation 1140 i.e. in the UL grant received in random access response (i.e. MSG2). In response gNB provides the requested SIBs (or SI messages) or it indicates UE to monitor SI window of one or more SI periods for receiving the requested SIBs/SI messages (i.e. network indicates that request SIBs/SI messages are broadcasted.) at operation 1150, as explained in Embodiment 1.

After transmission of MSG3, UE monitors the downlink for certain time duration i.e. ‘T’ ms to receive MSG4. If UE receives MSG4 including only the UE ID for contention resolution then it is implicit indication for UE to monitor SI window of one or more SI periods for receiving the requested SIB(s).

The method shown in FIG. 11, gives full flexibility to the network to decide to deliver the requested SIB(s) or SI message(s) either in broadcast manner or UE dedicated manner. For delivery of the requested SIB(s) since the UE is not moved to RRC connected state, the UE dedicated signaling is not subjected to link adaptation and hence there is difference in resource efficiency whether the requested SIB(s) or SI message(s) are delivered in MSG4 or through broadcast signaling in the SI windows.

### Embodiment 5

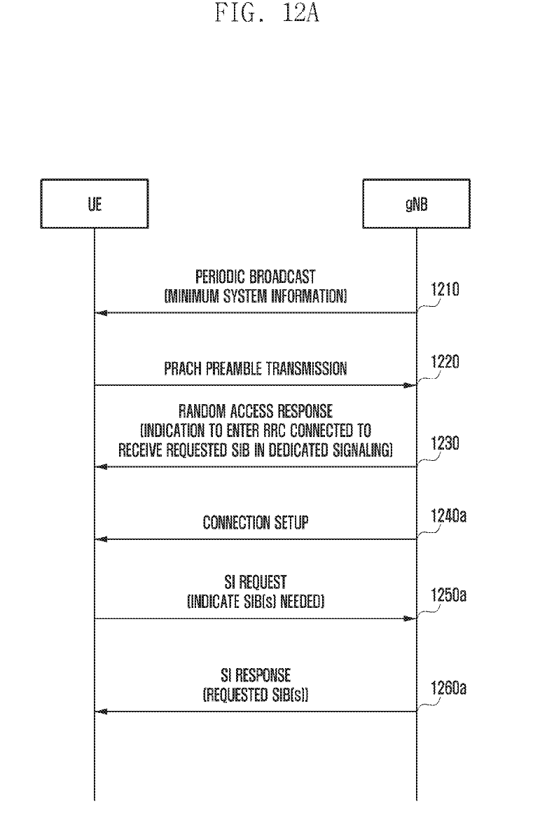

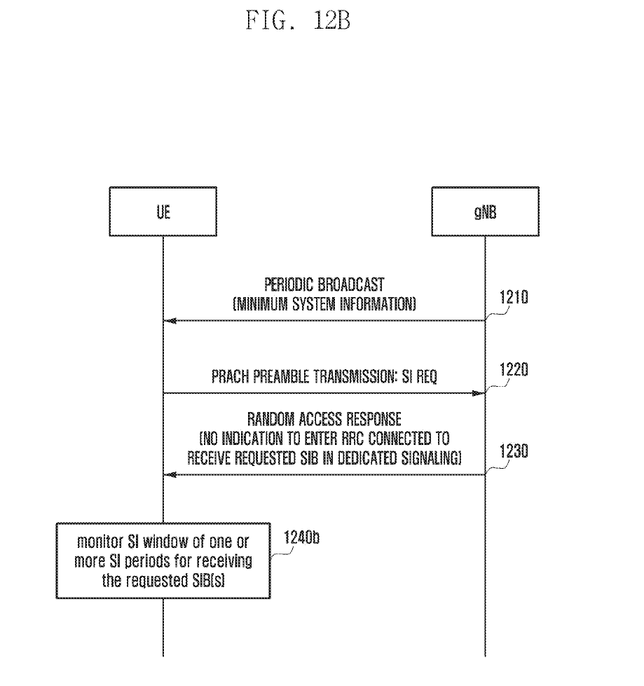

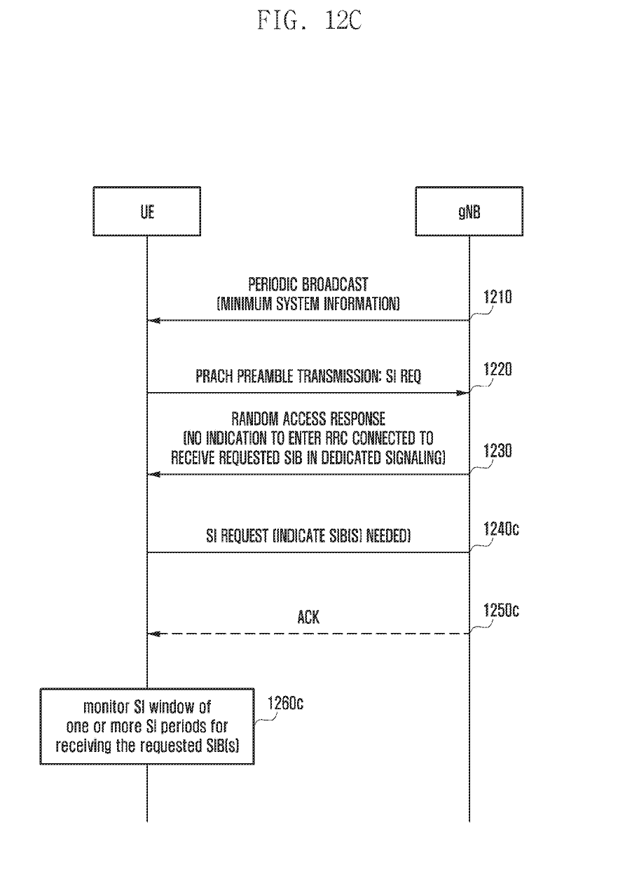

FIGS. 12A, 12B, and 12C illustrate SI response reception according to Embodiment 5 of the disclosure.

In an embodiment of FIGS. 12A, 12B and 12C, gNB broadcasts MSI (e.g. SIB 1) at operation 1210. The MSI (e.g. SIB 1) may be broadcasted periodically. UE transmits the PRACH preamble at operation 1220. The PRACH preamble(s) and/or PRACH resource(s) for requesting SI can be received by UE in the MSI (e.g. SIB 1) at operation 1210. UE may select PRACH preamble and/or PRACH resource for PRACH preamble transmission. After receiving the PRACH preamble transmission at operation 1220, gNB may indicate in RAR if UE should enter RRC connected state for receiving the SI at operation 1230.

a) Referring to FIG. 12A, if an indication to enter RRC connected is received by UE in RAR at operation 1230, UE shall enter RRC connected state. RAR shall include uplink (UL) grant in this case. If a connection setup between UE and gNB is performed at operation 1240a, UE may transmit SI request indicating SIB(s) needed at operation 1250a, and gNB may transmit SI response including requested SIB(s) at operation 1260a. UE may include the SI request together with connection request or connection resume request to gNB. Alternately UE can send the SI request after entering connected state.

b) Referring to FIG. 12B, if an indication to enter RRC connected is not received by UE in RAR at operation 1230, UE shall monitor SI window of one or more SI periods for receiving the requested SIB(s) or SI message(s) at operation 1240b if MSG1 based SI request is configured by network and UE has transmitted PRACH preamble transmission indicating SI request at operation 1220. UL grant is not included in RAR in this case. In MSG1 based SI request, SI request is indicated using PRACH preamble transmission i.e. MSG1.

c) Referring to FIG. 12C, if an indication to enter RRC connected is not received by UE at operation 1230, UE sends SI request using MSG3 at operation 1240c if MSG3 based SI request is configured by network. In MSG3 based SI request UE sends SI request in the UL grant received in random access response. UL grant is included in RAR in this case. After receiving the SI request at operation 1240c, gNB may transmit an acknowledgment indicating the SI request is received at operation 1250c. After transmitting the SI request at operation 1240c, UE monitors SI window of one or more SI periods for receiving the requested SIB(s) or SI message(s) at operation 1260c.

### Embodiment 6

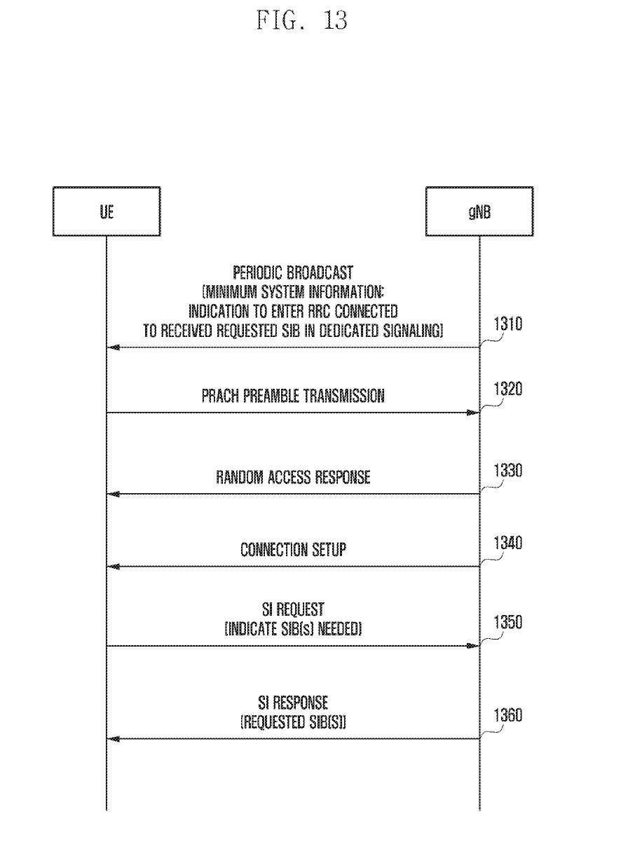

FIG. 13 illustrates an SI response reception according to Embodiment 6 of the disclosure.

In an embodiment of FIG. 13, gNB broadcasts MSI (e.g. SIB 1) at operation 1310. The MSI (e.g. SIB 1) may be broadcasted periodically and may indicate if UE should enter RRC connected state for receiving the SI provided on demand. If such an indication is received at operation 1310, UE shall enter RRC connected state to request SI. Specifically, UE transmits PRACH preamble at operation 1320, gNB transmits random access response at operation 1330, a connection setup between UE and gNB is performed at operation 1340, and UE transmits SI request indicating SIB(s) needed at operation 1350. UE may include the SI request together with connection request or connection resume request to gNB. Alternately UE can send the SI request after entering connected state. In response, gNB transmits SI response including requested SIB(s) at operation 1360.

### SI Request Transmission

Two mechanisms for requesting SI are being studied for 5G wireless communication systems.

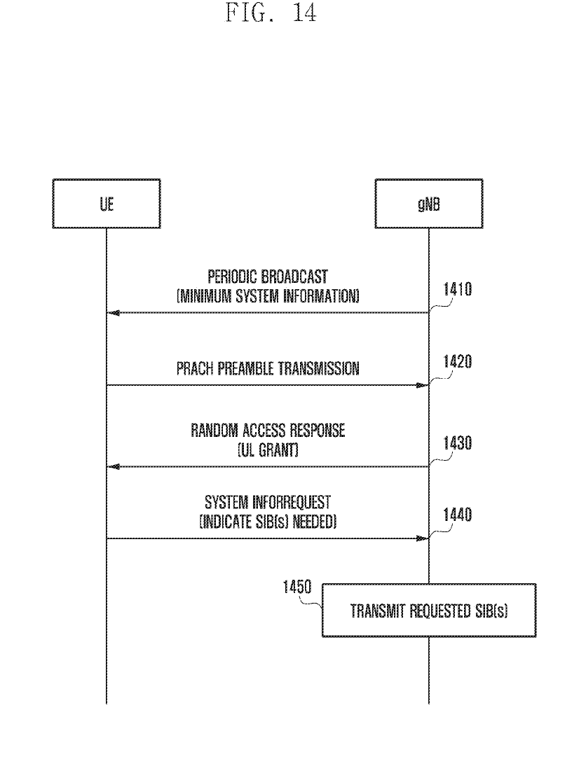

FIG. 14 shows a MSG3 based SI request approach according to an embodiment of the disclosure.

Referring FIG. 14, gNB broadcasts MSI (e.g. SIB 1) at operation 1410. The MSI (e.g. SIB 1) may be broadcasted periodically. UE transmits a PRACH preamble (i.e. MSG1) at operation 1420 based on the MSI. In response, gNB transmits a random access response (i.e. MSG2) including UL grant at operation 1430. In the UL grant received in the random access response corresponding to the PRACH preamble transmitted by UE, UE sends SI request message i.e. MSG3 at operation 1440. The SI request message can be a RRC message or a MAC CE. The information on the SIB(s) or SI message(s) needed by UE is included in SI request message. In response, gNB transmits requested SIB(s) at operation 1450.

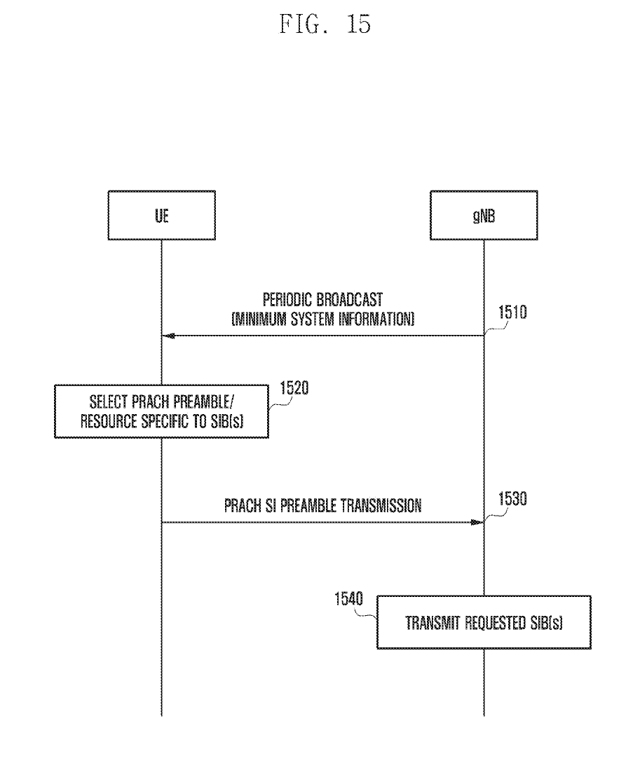

FIG. 15 shows a MSG1 based SI request approach according to an embodiment of the disclosure.

Referring FIG. 15, gNB broadcasts MSI (e.g. SIB 1) at operation 1510. The MSI (e.g. SIB 1) may be broadcasted periodically. UE selects PRACH preamble and/or PRACH resource specific to a SIB, set of SIBs or SI message which the UE wants to request at operation 1520. UE then transmits the PRACH preamble to request SI at operation 1530. It is assumed that PRACH preamble and/or PRACH resource specific to each SIB, set of SIBs or SI message are reserved and indicated in periodically broadcasted minimum SI (e.g. SIB 1). In response, gNB transmits requested SIB(s) at operation 1540.

In MSG1 based approach, reservation of PRACH preamble(s) and/or PRACH resource(s) are needed to indicate the requested SIB(s) or SI message(s). In MSG3 based approach there is no need to reserve PRACH preamble(s) and/or PRACH resource(s) for indicating requested SIB(s) or SI message(s). In case of MSG3 based approach RACH load increases with increase in SI requests. In case of MSG1 based approach increased SI requests does not have any impact on RACH load. PRACH preamble/resources are common for SI and non SI purposes. However, the impact to RACH load for non SI purposes can be avoided by reserving PRACH preamble/resources for SI purposes in MSG3 based approach. MSG3 based approach also leads to increased UE power consumption because of additional transmission of MSG3 in addition to MSG1. In case multiple UEs use the same PRACH preamble at the same time, MSG3 i.e. SI request will fail for all UEs except one. In case of MSG1 based approach there is no such failure as multiple UEs using the same PRACH preamble means same SI request.

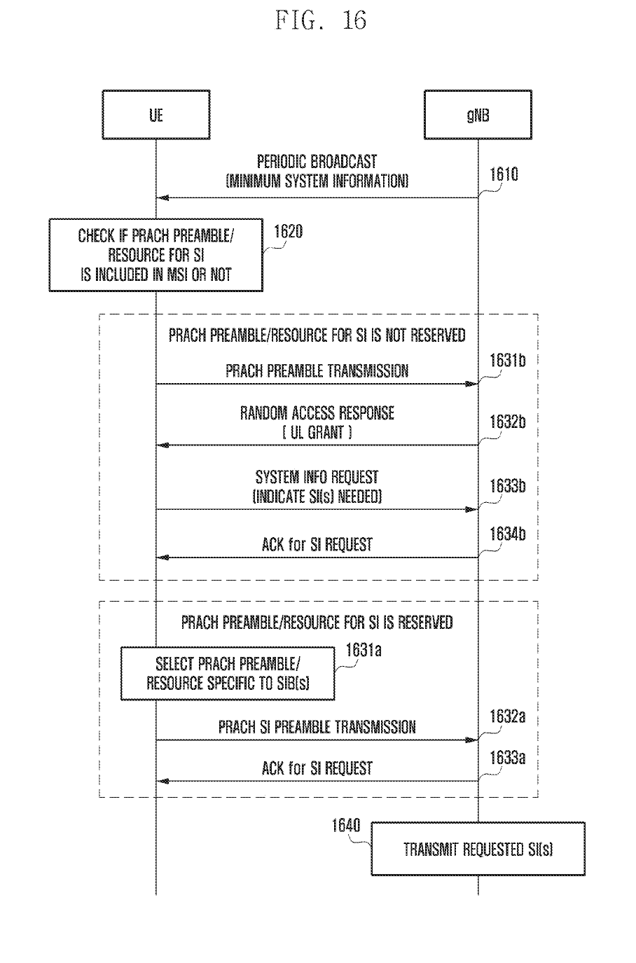

FIG. 16 illustrates an SI request transmission according to an embodiment of the disclosure.

Referring to FIG. 16, if the PRACH preamble and/or PRACH resource specific to each SIB, set of SIBs or SI message(s) are included in minimum SI (e.g. SIB 1) then SI request is indicated using MSG1 otherwise SI request is included in MSG3. Specifically, gNB broadcasts MSI (e.g. SIB 1) at operation 1610. The MSI (e.g. SIB 1) may be broadcasted periodically. UE checks if PRACH preamble/resource for SI is included in MSI or not at operation 1620.

If the PRACH preamble and/or PRACH resource specific to each SIB, set of SIBs or SI message(s) are included (i.e. reserved) in minimum SI (e.g. SIB 1), UE selects PRACH preamble and/or PRACH resource specific to a SIB, set of SIBs or SI message which the UE wants to request at operation 1631a. UE then transmits the PRACH preamble at operation 1632a. UE waits of acknowledgment for SI request from network (i.e. gNB or eNB or BS). For receiving acknowledgment for SI request, UE starts the ra-Response Window at the start of the first PDCCH occasion after a fixed duration of X symbols from the end of the PRACH preamble transmission. UE monitors the PDCCH of the SpCell for RAR identified by the RA-RNTI while ra-Response Window is running. Acknowledgment for SI request is considered received, if a downlink assignment has been received on the PDCCH for the RA-RNTI, the received TB is successfully decoded and RAR in the received TB includes only the RAPID corresponding to the transmitted PRACH preamble. After receiving the acknowledgment for SI request at operation 1633a, UE receives the requested SIB(s) or SI message(s) at operation 1640, as explained in Embodiment 1 of ‘SI Response Reception.’

On the contrary, if the PRACH preamble and/or PRACH resource specific to each SIB, set of SIBs or SI message(s) are not included (i.e. not reserved) in minimum SI (e.g. SIB 1), then UE initiates contention based random access procedure. Specifically, UE transmits the PRACH preamble at operation 1631b. UE then waits of RAR from network (i.e. gNB, eNB or BS). For receiving RAR at operation 1632b, UE starts the ra-Response Window at the start of the first PDCCH occasion after a fixed duration of X symbols from the end of the PRACH preamble transmission. UE monitors the PDCCH of the SpCell for RAR identified by the RA-RNTI while ra-Response Window is running. Acknowledgment for SI request is considered received, if a downlink assignment has been received on the PDCCH for the RA-RNTI, the received TB is successfully decoded and RAR in the received TB includes the RAPID corresponding to the transmitted PRACH preamble. UE then transmits SI request message in MSG3 at operation 1633b. MSG3 is the MAC PDU transmitted by UE using the UL grant received in RAR. SI request transmitted in MSG3 can be a SI request RRC message or a CCCH SDU. UE identity is included in this SI request RRC message transmitted in MSG3. In an alternate embodiment, SI request transmitted in MSG3 can be a MAC CE for SI request. UE identity is not included in this SI request MAC CE transmitted in MSG3. The information on the SIB(s) or SI message(s) needed by UE is included in SI request message. After transmitting SI request in MSG3 UE starts contention resolution timer and waits for acknowledgement for SI request. For receiving acknowledgement for SI request UE monitor for PDCCH addressed to its C-RNTI. UE considers contention resolution (or MSG4 reception) or acknowledgement for SI request as successful if it receives PDCCH addressed to its C-RNTI and ‘X’ bits of CCCH SDU (CCCH SDU includes SI request message) transmitted by UE in MSG3 is received in decoded TB (or MAC PDU). In another embodiment, UE considers contention resolution (or MSG4 reception) or acknowledgement for SI request as successful if it receives PDCCH addressed to its C-RNTI and SI ACK MAC CE is received in decoded TB (or MAC PDU). The requested SIB(s) or SI message(s) can be included in SI ACK MAC CE. After receiving the acknowledgment for SI request at operation 1634b, UE receives the requested SIB(s) or SI message(s) at operation 1640 as explained in Embodiment 1 of ‘SI Response Reception.’ In an embodiment, after receiving the acknowledgment for SI request MAC entity in UE may inform RRC that acknowledgment for SI request is received. RRC in UE then receives the requested SIB(s) or SI message(s) by monitoring SI window(s), as explained in Embodiment 1 of ‘SI Response Reception.’

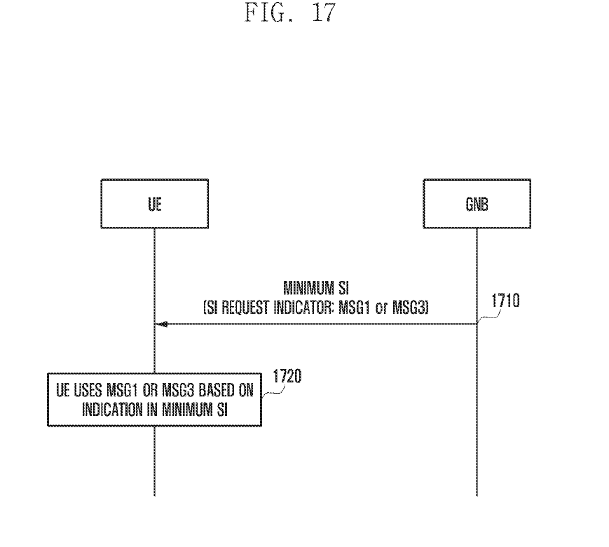

FIG. 17 illustrates an SI request transmission according to another embodiment of the disclosure.

In the embodiment of FIG. 17, network explicitly indicates in minimum SI (e.g. SIB 1) whether UE should use MSG1 or MSG3 for sending the SI request. Specifically, network (e.g. gNB, eNB or BS) transmits MSI (e.g. SIB 1) at operation 1710. The MSI (e.g. SIB 1) includes a SI request indicator indicating whether UE should use MSG1 or MSG3 for sending the SI request. If network indicates in minimum SI (e.g. SIB 1) that UE should use MSG1 for sending the SI request then it will also provide PRACH preamble and/or PRACH resource specific to each SIB or set of SIBs. UE uses operation described in FIG. 14 at operation 1720 if network indicates UE to use MSG3 for SI request. UE uses operation described in FIG. 15 at operation 1720 if network indicates UE to use MSG1 for SI request.

In an alternate embodiment, network may provide PRACH preamble and/or PRACH resource specific to some SIBs or sets of SIBs. For these SIBs or set of SIBs UE will use MSG1 to indicate SI request. For other SIBs or set of SIBs, UE will include the SI request in MSG3.

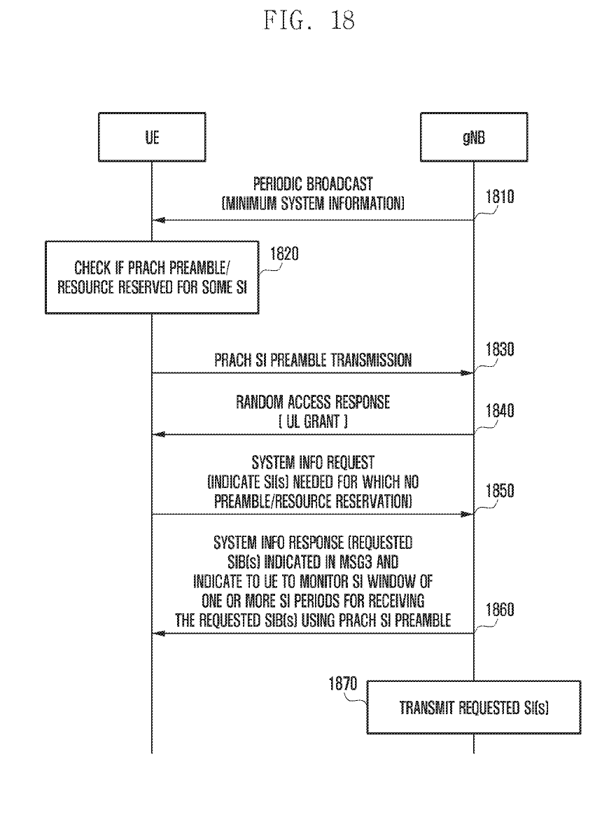

FIG. 18 illustrates an SI request transmission according to another embodiment of the disclosure.

In the embodiment of FIG. 18, network indicates in minimum SI the PRACH preamble and/or PRACH resource specific to some SIB(s) or set of SIB(s). For some other SIB(s) which are provided through on-demand basis there is no PRACH preamble and/or PRACH resource reservation then the UE request is based on both MSG1 and MSG3. Specifically, network (e.g. gNB, eNB or BS) broadcasts MSI (e.g. SIB 1) at operation 1810. The MSI (e.g. SIB 1) may be broadcasted periodically. UE checks if PRACH preamble/resource is reserved for some SI at operation 1820. UE transmits, at operation 1830, PRACH SI preamble or PRACH preamble based on whether PRACH preamble/resource is reserved. In response, network (e.g. gNB, eNB or BS) transmits random access response including UL grant at operation 1840. If no preamble/resource is reserved for SI(s), UE transmits a SI request (e.g. using MSG3) indicating SI(s) needed at operation 1850. In response, network (e.g. gNB, eNB or BS) transmits SI response at operation 1860. The SI response may include requested SIB(s) indicated in MSG3. Alternately, the SI may indicate to UE to monitor SI window of one or more SI periods for receiving the requested SIB(s) using PRACH SI preamble, and network (e.g. gNB, eNB or BS) may transmit requested SI(s) at operation 1870.

### Method of Signaling Mapping between PRACH Preambles and/or PRACH Resources and SIB(s)

In an embodiment MSI indicates mapping between a PRACH preamble and/or PRACH resource and one or more SIB(s). A list of such mapping can be signaled in MSI. The mapping information can be included in SIB (e.g. SIB 1) carrying scheduling information. The one or more SIBs mapped to a PRACH preamble and/or PRACH resource can be identified by an ‘N’ bit integer (say SI Request ID) where ‘N’ is number of supported SIBs. Alternately, the one or more SIBs mapped to a PRACH preamble and/or PRACH resource can be identified by an ‘N’ bit integer (say SI Request ID) where ‘N’ is number of SIBs provided on demand (i.e. not broadcasted periodically). Each value of this ‘N’ bit integer or SI Request ID identifies a unique combination or set of ‘N’ SIBs. For example, assume that there are 3 SIBs (SIB x, SIB y, SIB z) which are provided on demand. Each possible combination or set of these 3 SIBs can be identified by a 3 bit SI Request ID, as shown in table 1 below. Each value of SI request ID indicates a particular combination or set of SIBs. Note that set may have one SIB as well.

TABLE 1

| 3 bit SI | |
|---|---|
| Request ID | Corresponding SIBs |
| 0 | None |
| 1 | SIB x |
| 2 | SIB y |
| 3 | SIB x, SIB y |
| 4 | SIB z |
| 5 | SIB z, SIB x |
| 6 | SIB z, SIB y |
| 7 | SIB x, SIB y, SIB z |

The mapping between the values of SI Request ID and corresponding combination or set of SIBs can be explicitly signaled. Alternately this mapping can be implicit as explained further. Each bit in SI Request ID can be mapped to a SIB. The PRACH preamble and/or PRACH resource corresponding to a value of SI Request ID indicates SI request for a set of SIBs comprising of SIBs mapped to bits set to one in that value of SI Request ID. For example, if value of SI Request ID is 6 (equals 110 in binary), this means that LSB 2 and LSB 3 are set to one and LSB 1 is set to zero in binary representation of SI Request ID. So PRACH preamble and/or PRACH resource corresponding to SI Request ID value 6 indicates SI request for a set of SIBs comprising of SIBs mapped to LSB 2 and LSB 3. Mapping between a bit in SI Request ID and SIB can be pre-defined or signaled by network e.g. in MSI. Each bit in SI Request ID can be mapped to one or more SIBs.

### Embodiments of Explicit Mapping between a Bit in SI Request ID and SIB(s)

### Embodiment 1

First SIB in SIRequestIDSIB-MappingInfo corresponds to first least significant bit (or first most significant bit) of SI Request ID, second SIB in SIRequestIDSIB-Mappinglnfo corresponds to second least significant bit (or second most significant bit) of SI Request ID and so on.

```
SIRequestIDSIB-MappingInfo ::= SEQUENCE (SIZE (0..maxOnDemandSIB−1)) OF SIB-Type
OnDemandSIB-List ::= SEQUENCE (SIZE (0..maxOnDemandSIB−1)) OF SIB-Type
SIB-Type ::= ENUMERATED {
                                                sibTypeX, sibTypeY, sibTypeZ,
                                                spare2, spare1, ...}
```

### Embodiment 2

First entry in SIRequestIDSIB-Info corresponds to first least significant bit (or first most significant bit) of SI Request ID, second entry in SIRequestIDSIB-MappingInfo corresponds to second least significant bit (or second most significant bit) of SI Request ID and so on. Each entry in SIRequestIDSIB-Info is a list of one or more SIB(s).

```
SIRequestIDSIB-Info ::= SEQUENCE (SIZE (0..maxOnDemandSIB−1)) OF SIRequestIDSIB-MappingInfo
SIRequestIDSIB-MappingInfo ::= SEQUENCE (SIZE (0..maxOnDemandSIB−1)) OF SIB-Type
OnDemandSIB-List ::= SEQUENCE (SIZE (0..maxOnDemandSIB−1)) OF SIB-Type
SIB-Type ::= ENUMERATED {
                                                        sibTypeX, sibTypeY, sibTypeZ,
                                                        spare2, spare1, ...}
```

Mapping between a bit of SI Request ID and SIB can also be signaled implicitly. MSI may indicate which SIBs are provided on demand. If ‘N’ SIBs are provided on demand, SI Request ID size is ‘N” bits, the first SIB which is indicated as provided on demand can be mapped to LSB 1 of SI Request ID, the second SIB which is indicated as provided on demand can be mapped to LSB 2 of SI Request ID, the nth SIB which is indicated as provided on demand can be mapped to LSB n and so on.

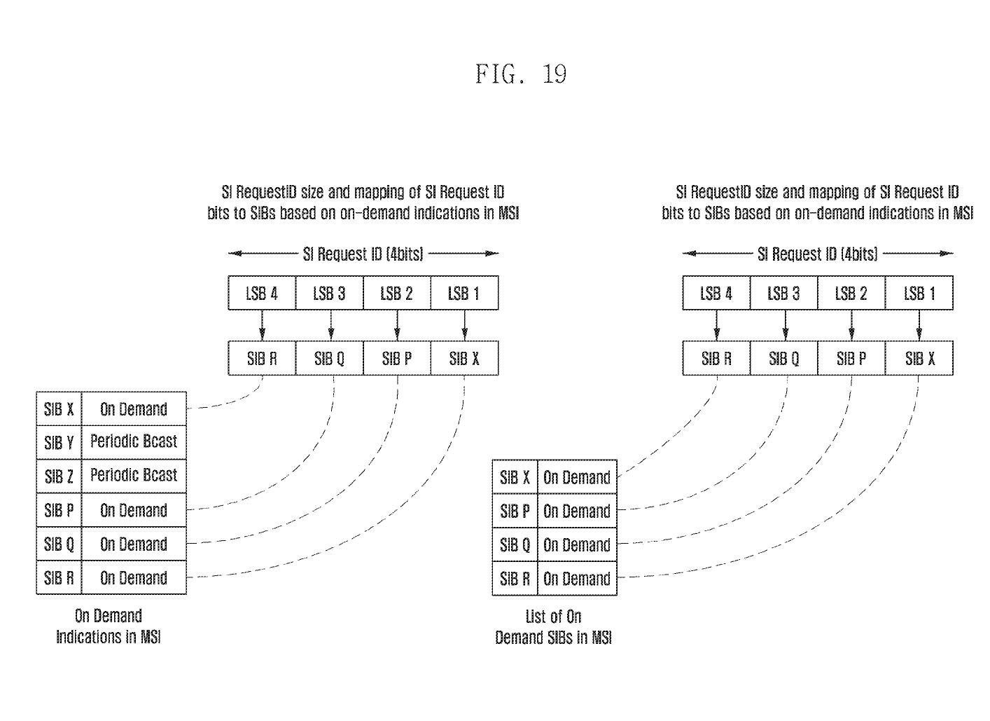

FIG. 19 shows mapping between a bit of SI Request ID and SIB according to an embodiment of the disclosure.

Referring to FIG. 19, there are four SIBs which are provided on demand, so SI Request ID size is 4 bits. The first SIB which is indicated as provided on demand is SIB X and hence it is mapped to LSB 1 of SI Request ID. The second SIB which is indicated as provided on demand is SIB P and hence it is mapped to LSB 2 of SI Request ID. The third SIB which is indicated as provided on demand is SIB Q and hence it is mapped to LSB 3 of SI Request ID. The fourth SIB which is indicated as provided on demand is SIB R and hence it is mapped to LSB 4 of SI Request ID. This approach reduces the overhead of SI request ID size as size is variable depending on number of SIBs provided on demand. An example of Abstract Syntax Notation.One (ASN.1) syntax of such implicit mapping is as follows:

```
OnDemandSIB-List ::= SEQUENCE (SIZE (0..maxOnDemandSIB−1)) OF SIB-Type
SIB-Type ::= ENUMERATED {
                                                        sibTypeX, sibTypeY, sibTypeZ,
                                                        spare2, spare1, ...}
```

First SIB in OnDemandSIB-List corresponds to first least significant bit (or first most significant bit) of SI Request ID, second SIB in SIRequestIDSIB-MappingInfo corresponds to second least significant bit (or second most significant bit) of SI Request ID and so on.

Mapping between a bit in SI Request ID and SIB can also be signaled implicitly. MSI may indicate which SIBs are provided on demand. If ‘N’ SIBs are provided on demand, SI Request ID size is ‘N” bits, the first SIB which is indicated as provided on demand can be mapped to most significant bit (MSB) 1 of SI Request ID, the second SIB which is indicated as provided on demand can be mapped to MSB 2 of SI Request ID, the nth SIB which is indicated as provided on demand can be mapped to MSB n and so on.

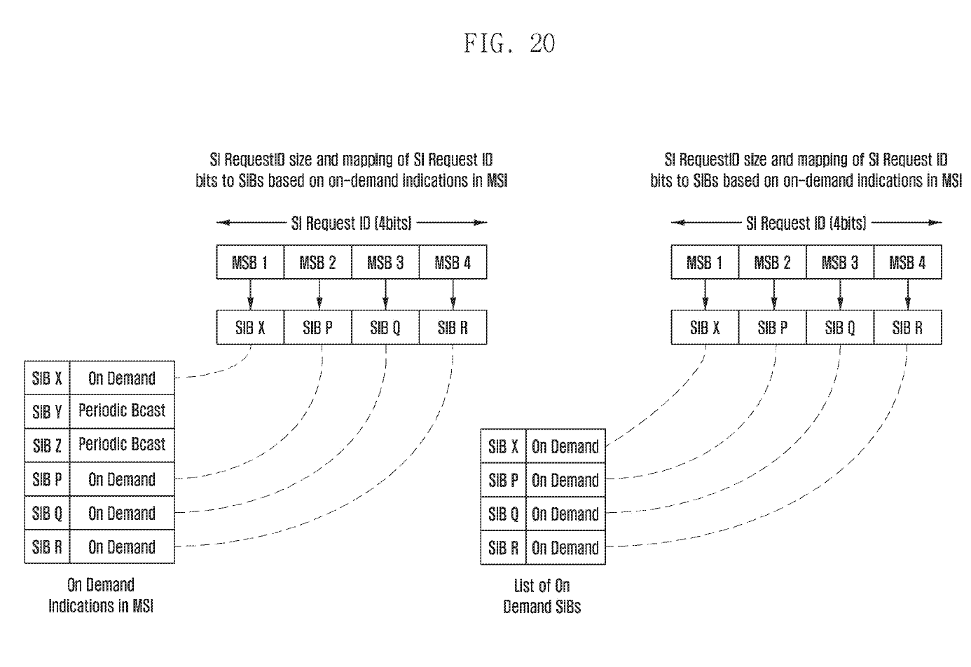

FIG. 20 shows mapping between a bit in SI Request ID and SIB according to another embodiment of the disclosure.

Referring to FIG. 20, there are four SIBs which are provided on demand, so SI Request ID size is 4 bits. The first SIB which is indicated as provided on demand is SIB X and hence it is mapped to MSB 1 of SI Request ID. The second SIB which is indicated as provided on demand is SIB P and hence it is mapped to MSB 2 of SI Request ID. The third SIB which is indicated as provided on demand is SIB Q and hence it is mapped to MSB 3 of SI Request ID. The fourth SIB which is indicated as provided on demand is SIB R and hence it is mapped to MSB 4 of SI Request ID. This approach reduces the overhead of SI request ID size as size is variable depending on number of SIBs provided on demand.

In an embodiment MSI indicates mapping between a PRACH preamble and/or PRACH resource and one or more SI messages instead of SIB(s). In this case the SI request ID explained earlier will indicate SI messages instead of SIBs.

The SI request ID as determined above can also be used by UE to indicate requested SIBs in SI request message or in SI request using MSG3 based approach.

### Paging Cycle Configuration

### Embodiment A:

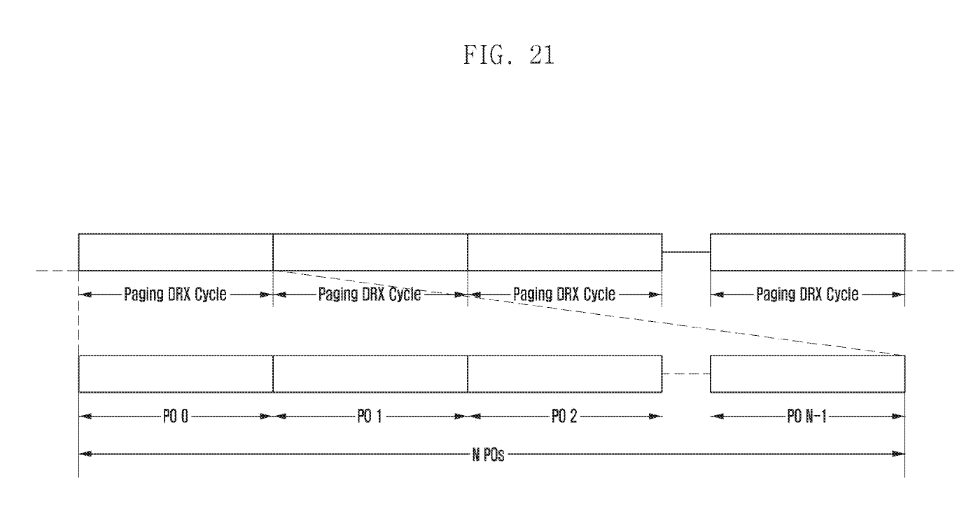

Network configures a paging discontinuous reception (DRX) cycle. FIG. 21 shows a paging DRX cycle comprising N paging occasion (PO) (or PO interval or paging transmit interval).

Referring to FIG. 21, the paging DRX cycle is configured by an integer N multiple of the duration of PO (or PO interval or paging transmit interval). The duration of PO (or PO interval or paging transmit interval) is signaled by network. The length of DRX cycle equals N* PO (or PO interval or paging transmit interval) duration. Each PO (or PO interval or paging transmit interval) comprises of multiple time slots. All time slots in PO (or PO interval or paging transmit interval) are not used for paging transmission. The one or more time slots in PO (or PO interval or paging transmit interval) used for paging transmission are signaled by network.

UEs are distributed in these POs (or PO intervals or paging transmit intervals) based on their UE IDs.

If network wants to use all POs (or PO intervals or paging transmit intervals) (i.e. all N POs) in paging DRX cycle for paging then UEs are distributed in these POs (or PO intervals or paging transmit intervals) as follows: A UE monitors paging in the Kth PO (or PO interval or paging transmit interval) of each DRX cycle where K=UE ID mod N. UE sleeps in other POs (or PO intervals or paging transmit intervals) of DRX cycle. For example, if DRX cycle consists of N=10 POs and UE ID=107 then this UE monitors K=107 mod 10=7th PO (or PO interval or paging transmit interval) in each DRX cycle.

If network want to use less than N POs (or PO intervals or paging transmit intervals) in paging DRX cycle, then UEs are distributed in these POs (or PO intervals or paging transmit intervals) as follows: A UE monitors paging in Kth PO (or PO interval or paging transmit interval) of DRX cycle where K=(N div N1)*(UE ID mod N1), where N1 is the number of POs (or PO intervals or paging transmit intervals) used by network for paging. N1 is signaled by network (e.g. in SI). UE sleeps in other POs (or PO intervals or paging transmit intervals) of DRX cycle. N is equal to DRX cycle length/PO duration. For example, if DRX cycle consists of N=10 POs network wants to use only N1=5 POs and UE ID=107 then this UE monitors K=(10/5)*(107mod 5)=4th PO in each DRX cycle. UE first determine the start of paging DRX cycle. The PO (or PO interval or paging transmit interval) which UE needs to monitor starts at an offset equal to K*P from the start of paging DRX cycle. P is the PO (or PO interval or paging transmit interval) duration. Some examples for determining the start of PO (or PO interval or paging transmit interval) which UE needs to monitor are as follows:

If Paging DRX cycle length is T subframes and PO (or PO interval or paging transmit interval) duration is P subframes then the starting subframe of UE's PO (or PO interval or paging transmit interval) is the subframe ‘X’ of radio frame (indicated by SFN) which satisfies the equation: (SFN*N2+X) mod T=K*P. N2 is number of subframes in a radio frame. N2 can be 10 in an example system.

If Paging DRX cycle length is T subframes, PO (or PO interval or paging transmit interval) duration is P subframes and ‘O’ is the offset in subframes of start of paging DRX cycle with respect to SFN 0, then the starting subframe of UE's PO is the subframe ‘X’ of radio frame (indicated by SFN) which satisfies the equation: (SFN*N2+X) mod T=O+K*P. N2 is number of subframes in a radio frame. N2 can be 10 in an example system.

If Paging DRX cycle length is T radio frames and PO (or PO interval or paging transmit interval) duration is P radio frames then the starting radio frame of UE's PO (or PO interval or paging transmit interval) is the radio frame (indicated by SFN) which satisfies the equation: SFN mod T=K*P. N2 is number of subframes in a radio frame. N2 can be 10 in an example system.

If Paging DRX cycle length is T radio frames, PO (or PO interval or paging transmit interval) duration is P radio frames and ‘O’ is the offset in radio frames of start of paging DRX cycle with respect to SFN 0, then the starting radio frame of UE's PO (or PO interval or paging transmit interval) is the radio frame (indicated by SFN) which satisfies the equation: SFN mod T=O+K*P. N2 is number of subframes in a radio frame. N2 can be 10 in an example system.

In an embodiment, paging time slot can be partitioned into several partitions/bands in frequency domain. Each UE only monitors a specific partition/band. This can reduce processing when system bandwidth is large as UE has to monitor only a narrow partition/band for monitoring paging in PO (or PO interval or paging transmit interval) duration. If the paging time slot is partitioned into X partitions/bands, then UE monitors Yth partition/band in time slot(s) of determined (i.e. Kth) PO (or PO interval or paging transmit interval) duration where Y=UE ID mod X. X is signaled by network.

In an alternate embodiment, paging time slot can be partitioned into several partitions/bands in frequency domain. Each UE only monitors a specific partition/band. This can reduce processing when system bandwidth is large as UE has to monitor only a narrow partition/band for monitoring paging in PO (or PO interval or paging transmit interval) duration. If the paging time slot is partitioned into X partitions/bands, then UE monitors Yth partition/band in time slot(s) of determined (i.e. Kth) PO (or PO interval or paging transmit interval) duration where Y=floor (UE ID/N1) mod X. X is signaled by network.

In case of omni beam operation, if the PO duration comprises of X paging time slots then UE monitors Yth paging time slot of determined (i.e. Kth) PO duration where Y=UE ID mod X. X is signaled by network.

Alternately, in case of omni beam operation, if the PO duration comprises of X paging time slots then UE monitors Yth paging time slot of determined (i.e. Kth) PO duration where Y=floor (UE ID/N1) mod X. X is signaled by network.

### Embodiment B

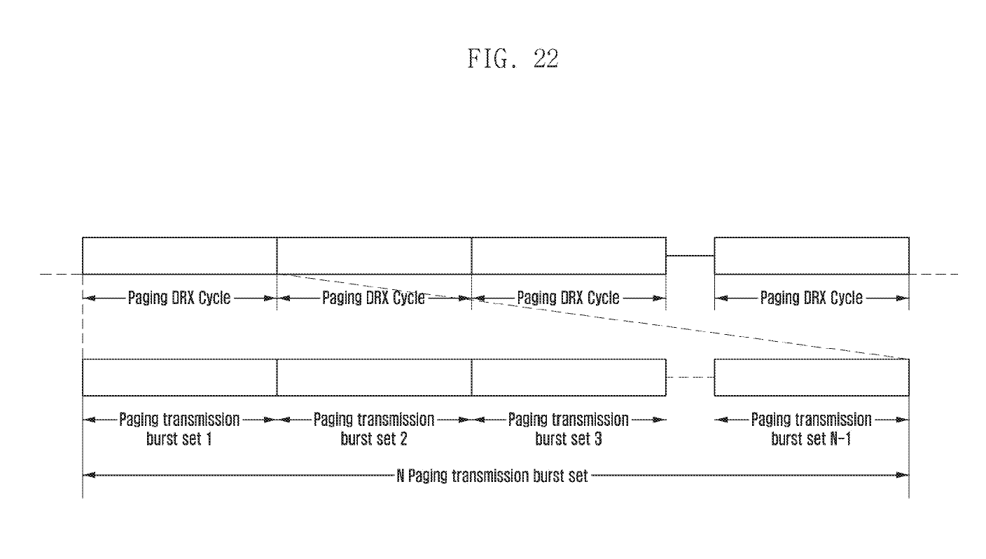

Network configures a paging DRX cycle. FIG. 22 shows a paging DRX cycle comprising N paging transmission burst set.

Referring to FIG. 22, the paging DRX cycle is configured by an integer N multiple of the duration of paging transmission burst set. The duration of paging transmission burst set is signaled by network. The length of DRX cycle equals N* paging transmission burst set duration. Each paging transmission burst set comprises of one or more paging bursts. Number of bursts within a burst set and periodicity of these bursts is configured by network. Each paging burst comprises of one or more paging blocks. The number of paging blocks in a paging burst is configured by network. The paging blocks in paging burst may or may not be consecutive. Paging is transmitted in each paging blocks of paging transmission burst set.

UEs are distributed in these paging transmission burst sets based on their UE IDs. Note that in this embodiment PO is paging transmission burst set. One or more these paging transmission burst sets may also be a synchronization signal burst set.

If network wants to use all paging transmission burst set (i.e. all N paging transmission burst set) in paging DRX cycle for paging then UEs are distributed in these paging transmission burst sets as follows: A UE monitors paging in the Kth paging transmission burst set of each DRX cycle where K=UE ID mod N. UE sleeps in other paging transmission burst set of DRX cycle. For example, if DRX cycle consists of N=10 paging transmission burst set and UE ID=107 then this UE monitors K=107 mod 10=7th paging transmission burst set in each DRX cycle.

If network want to use less than N paging transmission burst set in paging DRX cycle, then UEs are distributed in these paging transmission burst sets as follows: A UE monitors paging in Kth paging transmission burst set of DRX cycle where K=(N div N1)*(UE ID mod N1), where N1 is the number of paging transmission burst set used by network for paging. N1 is signaled by network. UE sleeps in other paging transmission burst set of DRX cycle. N is equal to DRX cycle length/Paging transmission burst set duration. For example, if DRX cycle consists of N=10 paging transmission burst set network wants to use only N1=5 paging transmission burst set and UE ID=107 then this UE monitors K=(10/5)*(107mod 5)=4th paging transmission burst set in each DRX cycle.

UE first determine the start of paging DRX cycle. The paging transmission burst set which UE needs to monitor starts at an offset equal to K*P from the start of paging DRX cycle. P is the paging transmission burst set duration. Some examples for determining the start of paging transmission burst set which UE needs to monitor are as follows:

If Paging DRX cycle length is T subframes and paging transmission burst set duration is P subframes then the starting subframe of UE's paging transmission burst set is the subframe ‘X’ of radio frame (indicated by SFN) which satisfies the equation: (SFN*N2+X) mod T=K*P. N2 is number of subframes in a radio frame. N2 can be 10 in an example system.

If Paging DRX cycle length is T subframes, paging transmission burst set duration is P subframes and ‘O’ is the offset in subframes of start of paging DRX cycle with respect to SFN 0, then the starting subframe of UE's paging transmission burst set is the subframe ‘X’ of radio frame (indicated by SFN) which satisfies the equation: (SFN*N2+X) mod T=O+K*P. N2 is number of subframes in a radio frame. N2 can be 10 in an example system.

If Paging DRX cycle length is T radio frames and paging transmission burst set duration is P radio frames then the starting radio frame of UE's paging transmission burst set is the radio frame (indicated by SFN) which satisfies the equation: SFN mod T=K*P. N2 is number of subframes in a radio frame. N2 can be 10 in an example system.

If Paging DRX cycle length is T radio frames, paging transmission burst set duration is P radio frames and ‘O’ is the offset in radio frames of start of paging DRX cycle with respect to SFN 0, then the starting radio frame of UE's paging transmission burst set is the radio frame (indicated by SFN) which satisfies the equation: SFN mod T=O+K*P. N2 is number of subframes in a radio frame. N2 can be 10 in an example system. In an embodiment, paging time slot can be partitioned into several partitions/bands in frequency domain. Each UE only monitors a specific partition/band. This can reduce processing when system bandwidth is large as UE has to monitor only a narrow partition/band for monitoring paging in paging transmission burst set. If the paging time slot is partitioned into X partitions/bands, then UE monitors Yth partition/band in time slot(s) of determined (i.e. Kth) paging transmission burst set where Y=UE ID mod X. X is signaled by network.

In an alternate embodiment, paging time slot can be partitioned into several partitions/bands in frequency domain. Each UE only monitors a specific partition/band. This can reduce processing when system bandwidth is large as UE has to monitor only a narrow partition/band for monitoring paging in paging transmission burst set. If the paging time slot is partitioned into X partitions/bands, then UE monitors Yth partition/band in time slot(s) of determined (i.e. Kth) paging transmission burst set where Y=floor (UE ID/N1) mod X. X is signaled by network.

In case of omni beam operation, if the paging burst set comprises of X paging blocks then UE monitors Yth paging block of determined (i.e. Kth) paging transmission burst set where Y=UE ID mod X. X is signaled by network.

Alternately, in case of omni beam operation, if the paging burst set comprises of X paging blocks then UE monitors Yth paging block of determined (i.e. Kth) paging burst set where Y=floor(UE ID/N1) mod X. X is signaled by network.

### Embodiment C

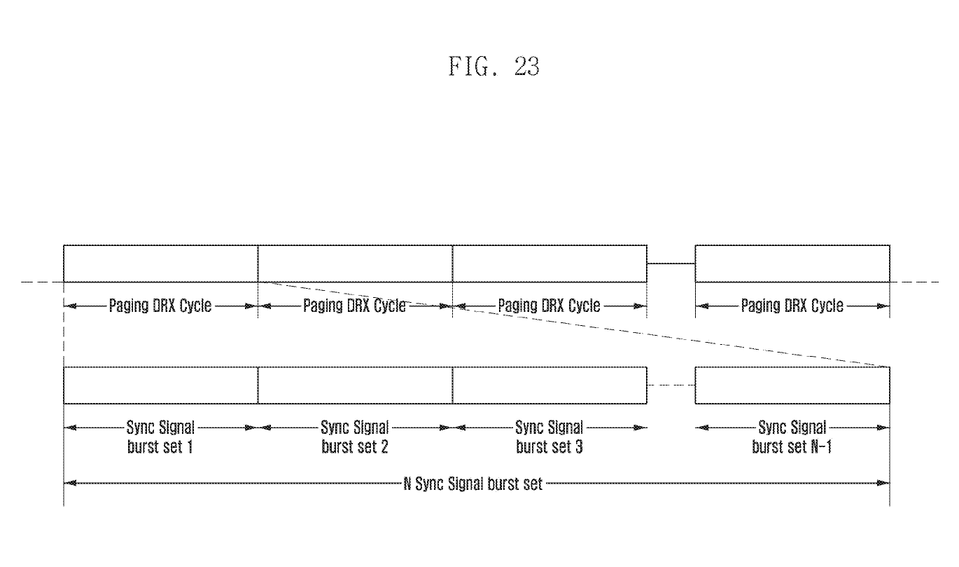

Network configures a paging DRX cycle. FIG. 23 shows a paging DRX cycle comprising N synchronization signal burst set.

Referring to FIG. 23, the paging DRX cycle is configured by an integer N multiple of the duration of synchronization signal burst set. The duration of synchronization signal burst set is signaled by network. The length of DRX cycle equals N* synchronization signal burst duration. Each synchronization signal burst set comprises of one or more synchronization signal bursts. Number of bursts within a burst set and periodicity of these bursts is configured by network. Each synchronization signal burst comprises of one or more SS blocks. The number of synchronization signal (SS) blocks in a synchronization signal burst is configured by network. The SS blocks in synchronization signal burst may or may not be consecutive. Paging is transmitted in each SS blocks of synchronization signal burst set.

UEs are distributed in these synchronization signal burst set based on their UE IDs. Note that in this embodiment PO is synchronization signal burst set.

If network wants to use all synchronization signal burst set (i.e. all N synchronization signal burst set) in paging DRX cycle for paging then UEs are distributed in these synchronization signal burst set as follows: A UE monitors paging in the Kth synchronization signal burst set of each DRX cycle where K=UE ID mod N. UE sleeps in other synchronization signal burst set of DRX cycle. For example, if DRX cycle consists of N=10 synchronization signal burst set and UE ID=107 then this UE monitors K=107 mod 10=7th synchronization signal burst set in each DRX cycle.

If network want to use less than N synchronization signal burst set in paging DRX cycle, then UEs are distributed in these synchronization signal burst set as follows: A UE monitors paging in Kth synchronization signal burst set of DRX cycle where K=(N div N1)*(UE ID mod N1), where N1 is the number of synchronization signal burst set used by network for paging. N1 is signaled by network. UE sleeps in other synchronization signal burst set of DRX cycle. For example, if DRX cycle consists of N=10 synchronization signal burst set network wants to use only N1=5 synchronization signal burst set and UE ID=107 then this UE monitors K=(10/5)*(107mod 5)=4th synchronization signal burst set in each DRX cycle.

UE first determine the start of paging DRX cycle. The synchronization signal burst set which UE needs to monitor starts at an offset equal to K*P from the start of paging DRX cycle. P is the synchronization signal burst set duration. Some examples for determining the start of synchronization signal burst set which UE needs to monitor are as follows:

If Paging DRX cycle length is T subframes and synchronization signal burst set duration is P subframes then the starting subframe of UE's synchronization signal burst set is the subframe ‘X’ of radio frame (indicated by SFN) which satisfies the equation: (SFN*N2+X) mod T=K*P. N2 is number of subframes in a radio frame. N2 can be 10 in an example system.

If Paging DRX cycle length is T subframes, synchronization signal burst set duration is P subframes and ‘O’ is the offset in subframes of start of paging DRX cycle with respect to SFN 0, then the starting subframe of UE's synchronization signal burst set is the subframe ‘X’ of radio frame (indicated by SFN) which satisfies the equation: (SFN*N2+X) mod T=O+K*P. N2 is number of subframes in a radio frame. N2 can be 10 in an example system.

If Paging DRX cycle length is T radio frames and synchronization signal burst set duration is P radio frames then the starting radio frame of UE's synchronization signal burst set is the radio frame (indicated by SFN) which satisfies the equation: SFN mod T=K*P. N2 is number of subframes in a radio frame. N2 can be 10 in an example system.

If Paging DRX cycle length is T radio frames, synchronization signal burst set duration is P radio frames and ‘O’ is the offset in radio frames of start of paging DRX cycle with respect to SFN 0, then the starting radio frame of UE's synchronization signal burst set is the radio frame (indicated by SFN) which satisfies the equation: SFN mod T=O+K*P. N2 is number of subframes in a radio frame. N2 can be 10 in an example system. In an embodiment, paging time slot can be partitioned into several partitions/bands in frequency domain. Each UE only monitors a specific partition/band. This can reduce processing when system bandwidth is large as UE has to monitor only a narrow partition/band for monitoring paging in synchronization signal burst set. If the paging time slot is partitioned into X partitions/bands, then UE monitors Yth partition/band in time slot(s) of determined (i.e. Kth) synchronization signal burst set where Y=UE ID mod X. X is signaled by network.

In an alternate embodiment, paging time slot can be partitioned into several partitions/bands in frequency domain. Each UE only monitors a specific partition/band. This can reduce processing when system bandwidth is large as UE has to monitor only a narrow partition/band for monitoring paging in synchronization signal burst set. If the paging time slot is partitioned into X partitions/bands, then UE monitors Yth partition/band in time slot(s) of determined (i.e. Kth) synchronization signal burst set where Y=floor (UE ID/N1) mod X. X is signaled by network.

In case of omni beam operation, if the synchronization signal burst set burst set comprises of X SS blocks then UE monitors Yth SS block of determined (i.e. Kth) synchronization signal burst set where Y=UE ID mod X. X is signaled by network.

Alternately, in case of omni beam operation, if the synchronization signal burst set comprises of X SS blocks then UE monitors Yth SS block of determined (i.e. Kth) synchronization signal burst set where Y=floor(UE ID/N1) mod X. X is signaled by network.

In an embodiment of the disclosure, network may signal whether paging is transmitted using beam sweeping in time slots of paging occasion or paging message is transmitted using repetition. In case of beam sweeping, UE does not need to monitor all time slots in paging occasion for receiving paging message. UE supporting multiple reception (RX) beams wakes up before the paging occasion, monitors the broadcast signals such as new radio (NR)-primary synchronization signal (PSS)/secondary synchronization signal (SSS)/broadcast channel (BCH), perform RX beam sweeping and determine the best/suitable downlink (DL) RX beam and DL transmission (TX) beam. For receiving paging, UE monitors using the determined DL RX beam, the time slot in paging occasion corresponding to the determined DL TX beam. UE supporting single RX beam, monitors the broadcast signals such as NR-PSS/SSS/BCH and determines the best/suitable DL TX beam. For receiving paging, UE monitors paging in the time slot in paging occasion corresponding to the determined DL TX beam. Mapping between the time slots in paging occasion and DL TX beams can be explicitly or implicitly signaled to UE. In an alternate embodiment, UE monitors the time slot in paging occasion corresponding to the SS block in which UE has received NR-PSS/SSS/BCH successfully or SS block in which UE has received NR-PSS/SSS/BCH with best or suitable quality. There can be one to one mapping (e.g. SS block 1 mapped to paging time slot 1, SS block 2 mapped to paging time slot 2 and so on) between SS block and paging time slot. This can be signaled by network. If there is one to one mapping, network just indicates using one bit whether there is one to one mapping or not. In case one to one mapping is not there, network may explicitly indicate which SS blocks are mapped to each paging time slot. In the absence of any mapping (one to one or explicit mapping) information, UE monitors the paging time slots in PO sequentially.

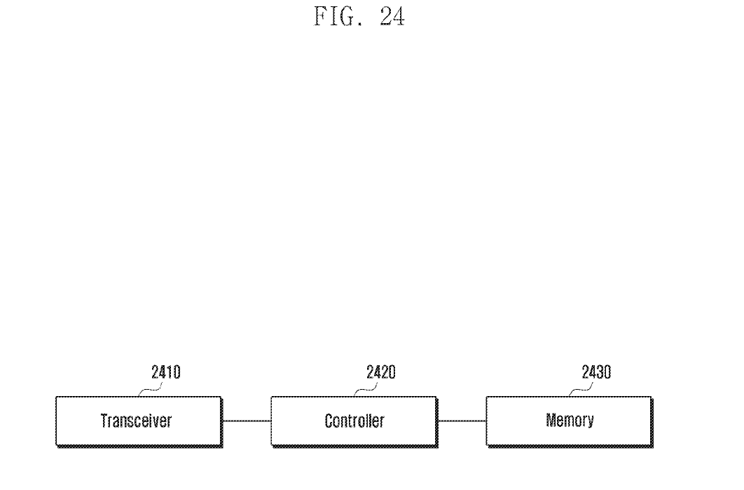

FIG. 24 is a block diagram of a UE according to an embodiment of the disclosure.

Referring to FIG. 24, a UE includes a transceiver (2410), a controller (2420) and a memory (2430). The controller (2420) may refer to a circuitry, an application-specific integrated circuit (ASIC), or at least one processor. The transceiver (2410), the controller (2420) and the memory (2430) are configured to perform the operations of the UE illustrated in the figures, e.g. FIGS. 1 to 18, or described above.

For example, the transceiver (2410) is configured to receive signals from a base station and transmit signals to the base station. The controller (2420) may be configured to control the transceiver (2410) to receive first system information from the base station. The first system information may refer to MSI. The controller (2420) may be configured to identify whether the first system information includes information on at least one of a PRACH preamble or PRACH resources associated with second system information. The second system information may refer to requested SI which the UE needs to acquire. The controller (2420) may be configured to control the transceiver (2410) to transmit a request for the second system information to the base station based on a result of the identification, and control the transceiver (2410) to receive the second system information from the base station.

If the first system information includes the information on the at least one of the PRACH preamble or the PRACH resources, the controller (2420) may control the transceiver (2410) to transmit the request for the second system information using the PRACH preamble (i.e. MSG1). Otherwise, i.e. if the first system information does not include such information, the controller (2420) may control the transceiver (2410) to transmit the request for the second system information using a message based on an uplink grant in a random access response (i.e. MSG3). If the request is transmitted using the message based on the uplink grant, the controller (2420) may control the transceiver (2410) to receive an acknowledgement for the request in a message for contention resolution (i.e. MSG4).

In addition, if the first system information includes information on duration in which the second system information is received, the controller (2420) may monitor periods or windows for receiving the second system information based on the information on the duration, as shown in FIGS. 1 to 7. The controller (2420) may monitor periods or windows for receiving the second system information based on time interval between the request for the second system information and an acknowledgement for the request, as shown in FIG. 3. The controller (2420) may control the transceiver (2410) to receive an indication indicating whether the UE needs to enter RRC connected state to receive the second system information or to monitor periods or windows for receiving the second system information, as shown in FIGS. 10, 12A, 12B, 12C and 13.

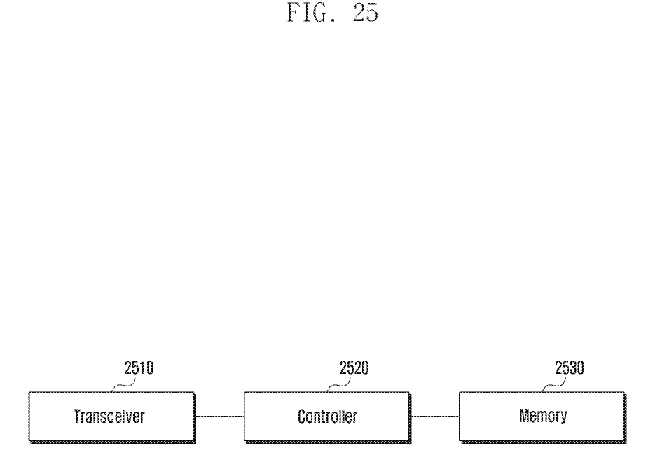

FIG. 25 is a block diagram of a base station according to an embodiment of the disclosure.

Referring to FIG. 25, a base station includes a transceiver (2510), a controller (2520) and a memory (2530). The controller (2520) may refer to a circuitry, an ASIC, or at least one processor. The transceiver (2510), the controller (2520) and the memory (2530) are configured to perform the operations of a base station (e.g. gNB, eNB, network) illustrated in the figures, e.g. FIGS. 1 to 18, or described above.

For example, the transceiver (2510) is configured to receive signals from a UE and to transmit signals to the UE. The controller (2520) is configured to control the transceiver (2510) to transmit first system information to the UE. The first system information may refer to MSI. The controller (2520) is configured to control the transceiver (2510) to receive a request for second system information from the UE based on whether the first system information includes information on at least one of a PRACH preamble or PRACH resources associated with the second system information. The second system information may refer to requested SI which the UE needs to acquire. The controller (2520) is configured to control the transceiver (2510) to transmit the second system information to the UE.

If the first system information includes the information on the at least one of the PRACH preamble or the PRACH resources, the controller (2520) may control the transceiver (2510) to receive the request for the second system information in the PRACH preamble (i.e. MSG1). Otherwise, i.e. if the first system information does not include such information, the controller (2520) may control the transceiver (2510) to receive the request for the second system information in a message based on an unlink grant in a random access response (i.e. MSG3). If the request is received in the message based on the unlink grant, the controller (2520) may control the transceiver (2510) to transmit an acknowledgement for the request using a message for contention resolution (i.e. MSG4).

In addition, the controller (2520) may control the transceiver (2510) to transmit information on duration in which the second system information is received, as shown in FIGS. 1 to 7. The controller (2520) may control the transceiver (2510) to transmit an indication indicating whether the UE needs to enter RRC connected state to receive the second system information or to monitor periods or windows for receiving the second system information, as shown in FIGS. 10, 12A, 12B, 12C and 13.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method by a user equipment (UE) for receiving system information, the method comprising:
receiving, from a base station, first system information;
identifying whether the first system information includes information on at least one of a physical random access channel (PRACH) preamble or PRACH resources associated with second system information;
transmitting, to the base station, a request for the second system information based on a result of the identification; and
receiving, from the base station, the second system information.

2. The method of claim 1, wherein the transmitting of the request further comprises:
transmitting the request for the second system information using the PRACH preamble if the first system information includes the information on the at least one of the PRACH preamble or the PRACH resources; and
transmitting the request for the second system information using a message based on an uplink grant in a random access response if the first system information does not include the information.

3. The method of claim 1, further comprising:
receiving, from the base station, an acknowledgement for the request in a message for contention resolution if the request is transmitted using the message based on the uplink grant.

4. The method of claim 1, further comprising:
receiving, from the base station, information on duration in which the second system information is received; and
monitoring periods or windows for receiving the second system information based on the information on the duration.

5. The method of claim 1, further comprising:
monitoring periods or windows for receiving the second system information based on time interval between the request for the second system information and an acknowledgement for the request.

6. The method of claim 1, further comprising:
receiving, from the base station, an indication indicating whether the UE needs to enter radio resource control (RRC) connected state to receive the second system information or to monitor periods or windows for receiving the second system information.

7. A method of a base station for transmitting system information, the method comprising:
transmitting, to a user equipment (UE), first system information;
receiving, from the UE, a request for second system information based on whether the first system information includes information on at least one of a physical random access channel (PRACH) preamble or PRACH resources associated with the second system information; and
transmitting, to the UE, the second system information.

8. The method of claim 7, wherein the receiving of the request further comprises:
receiving the request for the second system information in the PRACH preamble if the first system information includes the information on the at least one of the PRACH preamble or the PRACH resources; and
receiving the request for the second system information in a message based on an uplink grant in a random access response if the first system information does not include the information.

9. The method of claim 7, further comprising:
transmitting, to the UE, an acknowledgement for the request using a message for contention resolution if the request is received in the message based on the uplink grant.

10. The method of claim 7, further comprising:
transmitting, to the UE, at least one of information on duration in which the second system information is received, or an indication indicating whether the UE needs to enter radio resource control (RRC) connected state to receive the second system information or to monitor periods or windows for receiving the second system information.

11. A user equipment (UE) comprising:
a transceiver configured to:
receive signals from a base station, and
transmit signals to the base station; and
a controller coupled with the transceiver and configured to:
control the transceiver to receive first system information from the base station,
identify whether the first system information includes information on at least one of a physical random access channel (PRACH) preamble or PRACH resources associated with second system information,
control the transceiver to transmit a request for the second system information to the base station based on a result of the identification, and
control the transceiver to receive the second system information from the base station.

12. The UE of claim 11, wherein the controller is configured to:
control the transceiver to transmit the request for the second system information using the PRACH preamble if the first system information includes the information on the at least one of the PRACH preamble or the PRACH resources, and
control the transceiver to transmit the request for the second system information using a message based on an uplink grant in a random access response if the first system information does not include the information.

13. The UE of claim 11, wherein the controller is further configured to control the transceiver to receive acknowledgement for the request in a message for contention resolution if the request is transmitted using the message based on the uplink grant.

14. The UE of claim 11, wherein the controller is further configured to:
control the transceiver to receive information on duration in which the second system information is received from the base station, and
monitor periods or windows for receiving the second system information based on the information on the duration.

15. The UE of claim 11, wherein the controller is further configured to monitor periods or windows for receiving the second system information based on time interval between the request for the second system information and an acknowledgement for the request.

16. The UE of claim 11, wherein the controller is further configured to control the transceiver to receive an indication indicating whether the UE needs to enter radio resource control (RRC) connected state to receive the second system information or to monitor periods or windows for receiving the second system information from the base station.

17. A base station comprising:
a transceiver configured to:
receive signals from a user equipment (UE), and
transmit signals to the UE; and
a controller coupled with the transceiver and configured to:
control the transceiver to transmit first system information to the UE,
control the transceiver to receive a request for second system information from the UE based on whether the first system information includes information on at least one of a physical random access channel (PRACH) preamble or PRACH resources associated with the second system information, and
control the transceiver to transmit the second system information to the UE.

18. The base station of claim 17, wherein the controller is further configured to:
control the transceiver to receive the request for the second system information in the PRACH preamble if the first system information includes the information on the at least one of the PRACH preamble or the PRACH resources; and
control the transceiver to receive the request for the second system information in a message based on an uplink grant in a random access response if the first system information does not include the information.

19. The base station of claim 17, wherein the controller is further configured to control the transceiver to transmit an acknowledgement for the request using a message for contention resolution to the UE if the request is received in the message based on the uplink grant.

20. The base station of claim 17, wherein the controller is further configured to control the transceiver to transmit at least one of information on duration in which the second system information is received, or an indication indicating whether the UE needs to enter radio resource control (RRC) connected state to receive the second system information or to monitor periods or windows for receiving the second system information to the UE.
